(19) United States
(12) Patent Application Publication
(10) Pub. No.: US 2026/0251884 A1
(43) Pub. Date: Aug. 27, 2026

(54) OPTICAL SYSTEM AND CAMERA MODULE COMPRISING SAME

(71) Applicant: LG INNOTEK CO., LTD., Seoul (KR)

(72) Inventor: Hye Jung JEONG, Seoul (KR)

(21) Appl. No.: 18/870,521

(22) PCT Filed: Jun. 7, 2023
(86) PCT No.: PCT/KR2023/007787

§ 371 Date: Nov. 29, 2024

(30) Foreign Application Priority Data
Jun. 7, 2022 (KR) 10-2022-0068941

(51) Int. Cl. G02B 13/00; G02B 3/00; G02B 9/64; G03B 30/00; H04N 23/55

(52) U.S. Cl. CPC G02B 13/0045; G02B 9/64; H04N 23/55; G02B 2003/0093; G03B 30/00

(57) ABSTRACT

An optical system disclosed in the embodiment of the invention includes first to ninth lenses disposed along an optical axis toward a sensor side from an object side, wherein the first lens has positive refractive power on the optical axis and has a meniscus shape convex toward the object side, the second lens has a positive refractive power on the optical axis and has a shape in which both sides are convex, and the ninth lens has a negative refractive power on the optical axis, and has a meniscus shape convex toward the object side, a lens that has a maximum absolute value of a focal lengths among the first to ninth lenses is the fourth lens, and a lens surface that has a maximum absolute value of curvature radii in the first to ninth lenses is an object-side surface of the sixth lens, the focal length of the first lens is F1, the focal length of the ninth lens is F9, and the following Equation may satisfy: −0.5<F9/F1<0.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

Therefore, a new optical system capable of solving the above problems is required.

### DISCLOSURE

### Technical Problem

An embodiment of the invention provides an optical system with improved optical properties.

The embodiment provides an optical system having excellent optical performance at the center and periphery portions of the field of view.

The embodiment provides an optical system capable of having a slim structure.

### Technical Solution

An optical system according to an embodiment of the invention comprises first to ninth lenses disposed along an optical axis toward a sensor side from an object side, wherein the first lens has positive refractive power on the optical axis and has a meniscus shape convex toward the object side, the second lens has a positive refractive power on the optical axis and has a shape in which both sides are convex, and the ninth lens has a negative refractive power on the optical axis, and has a meniscus shape convex toward the object side, a lens that has a maximum absolute value of a focal lengths among the first to ninth lenses is the fourth lens, and a lens surface that has a maximum absolute value of curvature radii in the first to ninth lenses is an object-side surface of the sixth lens, the focal length of the first lens is F1, the focal length of the ninth lens is F9, and the following Equation may satisfy: −0.5<F9/F1<0.

According to an embodiment of the invention, an optical axis distance from a center of the object-side surface of the first lens to an upper surface of an image sensor is TTL, ½ of the diagonal length of the image sensor is ImgH, and the following Equation may satisfy: 0.5<TTL/(2*ImgH)<0.9.

According to an embodiment of the invention, a refractive index of the first lens is n1, an Abbe number is v1, a refractive index of the third lens is n3, and an Abbe number is the first lens v3, and the following equation may satisfy: (v3*n3)<(v1)*n1). Additionally, the following Equations may satisfy: n1<1.6, and n1<n3 and v1>v3.

According to an embodiment of the invention, a refractive index of the second lens is n2, an Abbe number is v2, and the following Equation may satisfy: v3*n3<v2*n2.

According to an embodiment of the invention, a total focal length of the optical system is F, a brightness of the optical system is F #, and the following Equations may satisfy: 2<F/F #<4, where F #<2.3.

According to an embodiment of the invention, the sixth lens may have positive refractive power.

According to an embodiment of the invention, a lens having a minimum effective diameter among the first to ninth lenses may be the second lens, and a lens having a maximum effective diameter among the first to ninth lenses may be the ninth lens.

According to an embodiment of the invention, a center distance between the third lens and the fourth lens may be greater than a center distance between the second lens and the third lens, and greater than a center distance between the fourth lens and the fifth lens.

According to an embodiment of the invention, an object-side surface of the fourth lens may have a curvature radius of 500 mm or more on the optical axis.

An optical system according to an embodiment of the invention includes a first lens having a meniscus shape convex toward an object; a second lens disposed on a sensor side of the first lens; a third lens disposed on a sensor side of the second lens; a fourth lens disposed on a sensor side of the third lens; n-th lens closest to an image sensor; an n-1th lens disposed on an object side of the n-th lens; two or more lenses disposed between the fourth lens and the n-1th lens, wherein the second lens has a minimum effective diameter among the lenses, the n-th lens has the maximum effective diameter among the lenses of the optical system, the first lens to the n-th lens are aligned along an optical axis, a center distance between the third and fourth lenses is the maximum among center distances between the first to fourth lenses, and a curvature radius of an object-side surface of the fourth lens is L4R1, a curvature radius of the sensor-side surface of the fourth lens is L4R2, and the following Equation may satisfy: 100<| L4R2|<|L4R1|.

According to an embodiment of the invention, a sum of center thicknesses of the first to n-th lenses is ECT, a sum of center distances between the first to n-th lenses is ECG, and the following Equation may satisfy: ΣCG<ECT.

According to an embodiment of the invention, a total number of lenses is n, and the following Equation may satisfy: 5<(CT_Max+CG_Max)*n<20.

According to an embodiment of the invention, a number of lenses with a refractive index of less than 1.6 at the d-line among the lenses may be 5 or more, and a number of lenses with an Abbe number of more than 45 among the lenses may be 5 or more.

According to an embodiment of the invention, a sum of the refractive indices at the d-line of the lenses is ΣIndex, a sum of the Abbe numbers of the lenses is ΣAbbe, and the following Equation may satisfy: 10<ΣAbbe/ΣIndex<50.

According to an embodiment of the invention, an optical axis distance from a center of an object-side surface of the first lens to an upper surface of the image sensor is TTL, ½ of a diagonal length of the image sensor is ImgH, and the following Equation may satisfy: 1<TTL/ImgH<2.

According to an embodiment of the invention, an object-side surface and a sensor-side surface of the n-th lens have a critical point, an object-side surface and a sensor-side surface of the n-1th lens have a critical point, and a sensor-side surface of the n-th lens has a critical point. The critical point of the sensor-side surface of the n-th lens may be disposed closer to an edge than the critical points of the object-side and sensor-side surfaces of the n-1th lens.

An optical system according to an embodiment of the invention includes a first lens group having first to third lenses on an object side; a second lens group disposed on a sensor side of the first lens group and having five or more lenses than a number of lenses of the first lens group; and an aperture stop disposed around an object-side surface or sensor-side surface of a second lens, wherein the first lens group has positive refractive power, the second lens group has negative refractive power, and the second lens group has a negative refractive power, the second lens has a convex object-side surface and a convex sensor-side surface on the optical axis, an optical axis distance from an object-side center of the first lens group to an image sensor is TTL, a field of view of the optical system is FOV, and ½ of a diagonal length of the image sensor is ImgH, n is a total number of lenses, and the following Equations may satisfy: (TTL*n)<FOV, and 0.5<TTL/(2*ImgH)<0.9.

A camera module according to an embodiment of the invention includes an image sensor disposed on the sensor side of a plurality of lenses; and an optical filter disposed between the image sensor and a last lens, wherein an optical system includes the optical system according to any one of claims 1, 11, or 18, F is the total focal length, TTL is a distance in an optical axis from a center of an object side of a lens closest to an object side to an upper surface of the image sensor, ImgH is ½ of a maximum diagonal length of the image sensor, the following Equation may satisfy: 0.5<F/TTL<1.5, and 1<TTL/ImgH<2.

### Advantageous Effects

The optical system and the camera module according to the embodiment may have improved optical properties. In detail, the optical system may have improved aberration characteristics and resolution according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the field of view (FOV).

The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to a first embodiment of the invention.

FIG. 2 is an explanatory diagram showing a relationship between an image sensor and an n-th lens to an n-1th lens in the optical system according to embodiments of the invention.

FIG. 3 is a table showing lens data according to an embodiment having the optical system of FIG. 1.

FIG. 4 is an example of aspheric coefficients of lenses according to embodiments of the optical system of FIG. 1.

FIG. 5 is a configuration diagram of an optical system and a camera module according to a second embodiment of the invention.

FIG. 6 is a table showing lens data according to an embodiment having the optical system of FIG. 5.

FIG. 7 is an example of the aspheric coefficient of the lenses of the optical system of FIG. 5.

FIG. 8 is a configuration diagram of an optical system and a camera module according to a third embodiment of the invention.

FIG. 9 is a table showing lens data according to an embodiment having the optical system of FIG. 8.

FIG. 10 is an example of the aspheric coefficient of the lenses of the optical system of FIG. 8.

FIG. 11 is a diagram showing a camera module according to an embodiment applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object-side surface with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

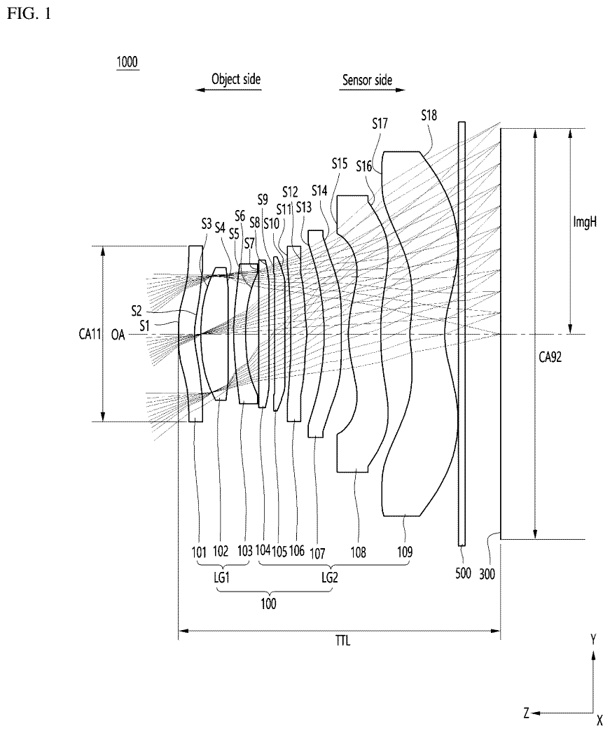

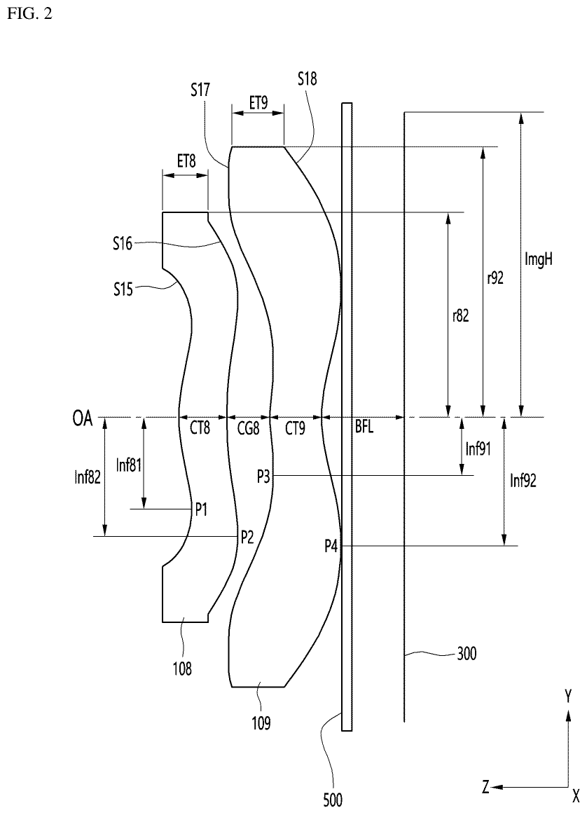

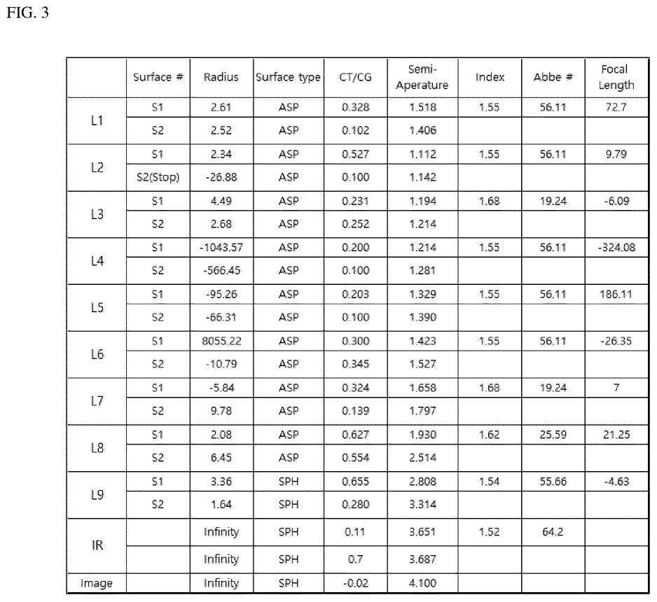

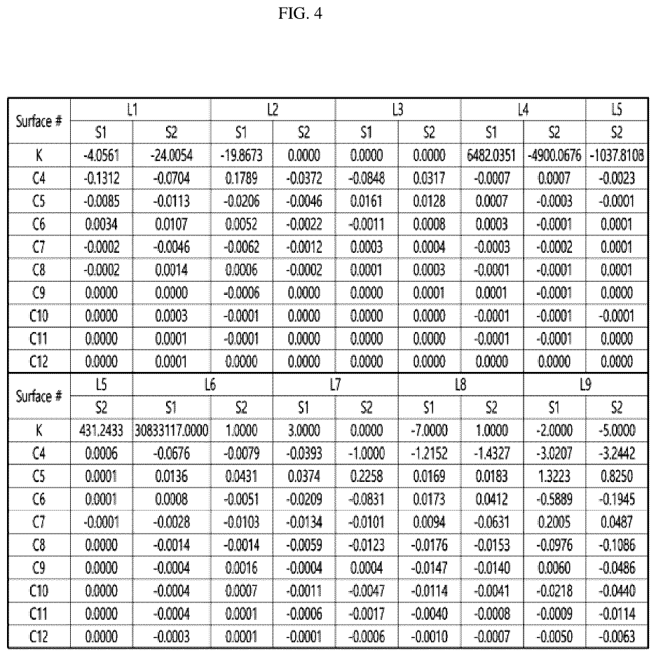

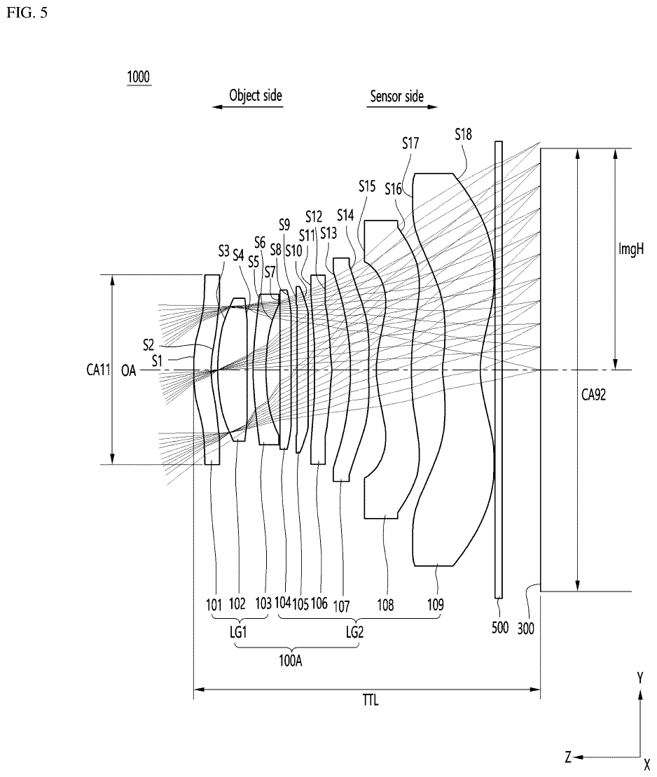

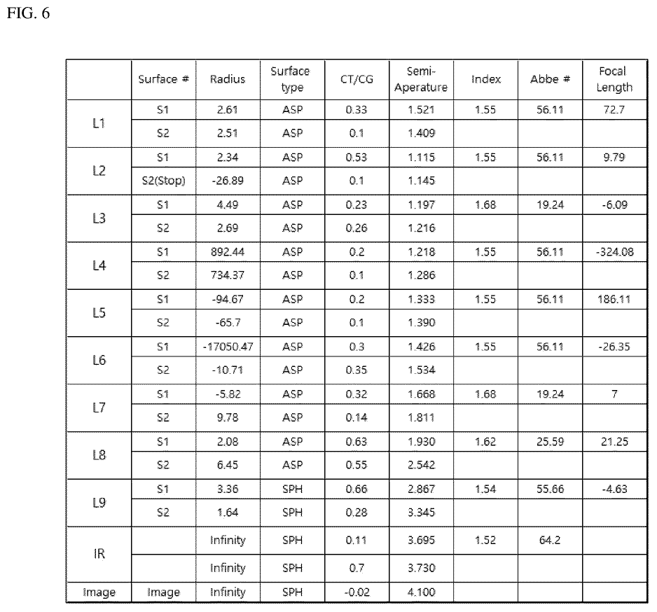

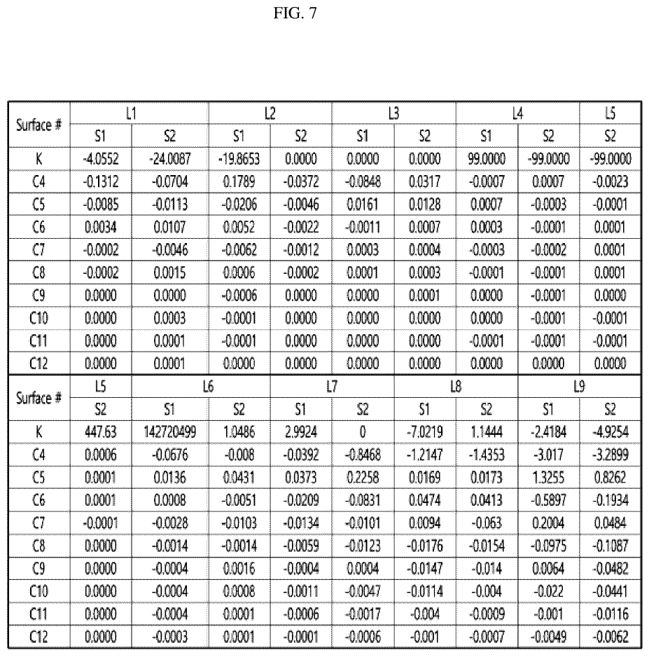

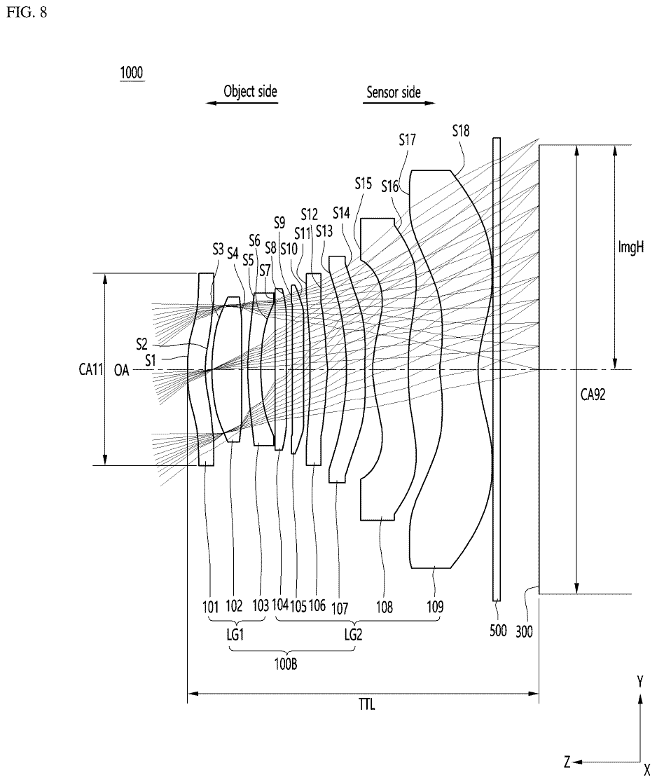

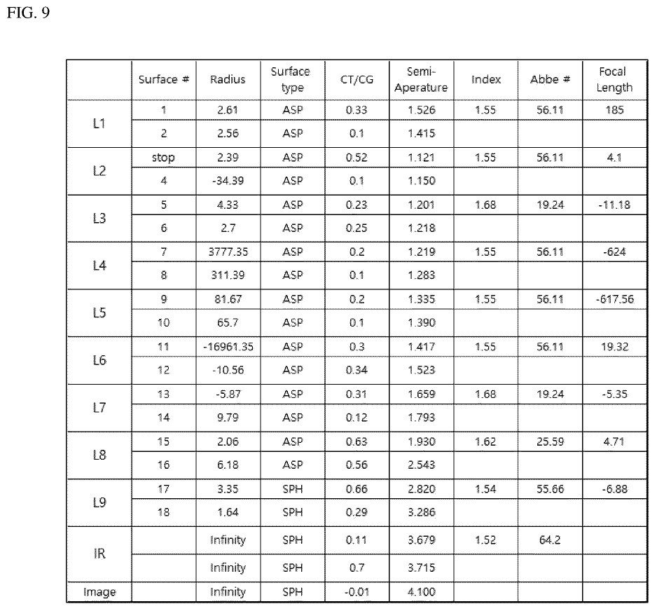

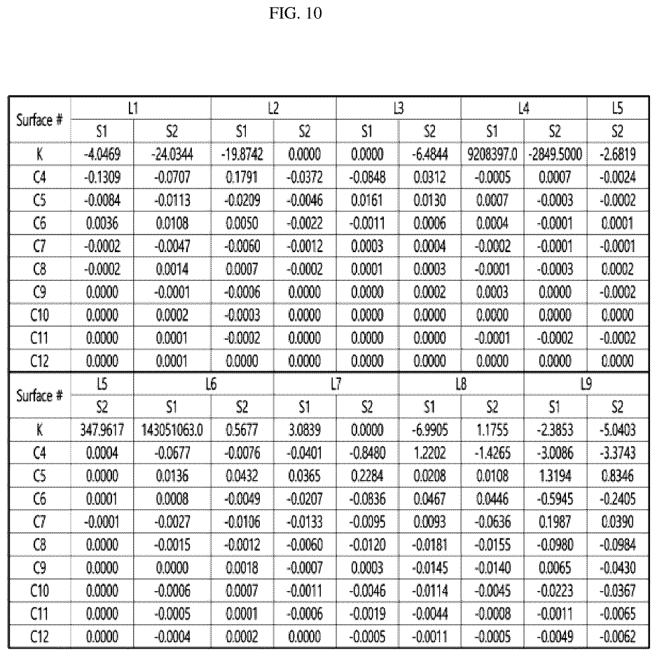

FIG. 1 is a configuration diagram of an optical system and a camera module according to a first embodiment of the invention, FIG. 2 is an explanatory diagram showing a relationship between an image sensor and an n-th lens to an n-1th lens in the optical system according to embodiments of the invention, FIG. 3 is a table showing lens data according to an embodiment having the optical system of FIG. 1, FIG. 4 is an example of aspheric coefficients of lenses according to embodiments of the optical system of FIG. 1, FIG. 5 is a configuration diagram of an optical system and a camera module according to a second embodiment of the invention, FIG. 6 is a table showing lens data according to an embodiment having the optical system of FIG. 5, FIG. 7 is an example of the aspheric coefficient of the lenses of the optical system of FIG. 5, FIG. 8 is a configuration diagram of an optical system and a camera module according to a third embodiment of the invention, FIG. 9 is a table showing lens data according to an embodiment having the optical system of FIG. 8, FIG. 10 is an example of the aspheric coefficient of the lenses of the optical system of FIG. 8.

Referring to FIGS. 1 to 10, the optical system 1000 or camera module may include a plurality of lens groups LG1 and LG2. For example, the optical system 1000 may include a first lens group LG1 and a second lens group LG2 sequentially arranged along the optical axis OA from the object-side toward the image sensor 300. The second lens group LG2 may be disposed between the first lens group LG1 and the image sensor 300. Each of the plurality of lens groups LG1 and LG2 includes at least two lenses. The number of lenses of the second lens group LG2 may be greater than the number of lenses of the first lens group LG1, for example, 1.5 times or more than the number of lenses of the first lens group LG1, for example, in a range of 1.5 to 2.5 times.

The first lens group LG1 may include two or more lenses. The first lens group LG1 may include, for example, three lenses. The second lens group LG2 may include five or more lenses and seven or less lenses. The number of lenses of the second lens group LG2 may be five or more than the number of lenses of the first lens group LG1. The second lens group LG2 may include, for example, six lenses. The optical system 1000 may include eleven or less lenses or ten or less lenses.

In the optical system 1000, the total track length TTL may be less than 80% of the diagonal length of the image sensor 300, for example, in the range of 60% to 80% or 70% to 80%. The TTL is the distance in the optical axis OA from the object-side surface of the first lens 101 closest to the object to the upper surface of the image sensor 300. The diagonal length of the image sensor 300 is twice ImgH, and ImgH is half the diagonal length of the image sensor 300. Accordingly, a slim optical system and a camera module having the same may be provided. The total number of lenses in the first and second lens groups LG1 and LG2 is 8 to 10.

The first lens group LG1 may have positive (+) refractive power. The second lens group LG2 may have a negative refractive power different from that of the first lens group LG1. The first lens group LG1 and the second lens group LG2 have different focal lengths, so they may have good optical performance in the center and periphery portions of the field of view (FOV). The refractive power is the reciprocal of the focal length.

The first lens group LG1 may include a stack of lenses having a meniscus shape convex toward the object. At least one or two of the lenses of the first lens group LG1 may be provided on the object-side surface and the sensor-side surface without a critical point from the optical axis to the end of the effective region. Accordingly, since the minimum critical point is provided to the lenses of the first lens group LG1, the effective diameter of the lenses of the second lens group LG2 adjacent to the first lens group LG1 may not be increased.

In the second lens group LG2, the number of lenses having a critical point on at least one of the object-side surface and the sensor-side surface may be equal to or smaller than the number of lenses without a critical point on at least one of the object-side surface and the sensor-side surface. Accordingly, the TTL may be reduced and the size of the image sensor 300 may be increased by the lens surfaces of the second lens group LG2.

The first lens group LG1 may refract the light incident through the object-side surface to collect it, and the second lens group LG2 may refract the light emitted through the first lens group LG1 to the periphery portion of the image sensor 300. In addition, the two lens surfaces of the first and second lens groups LG1 and LG2 facing each other may have, for example, the concave sensor-side surface of the first lens group LG1, and the concave object-side surface of the second lens group LG2. Additionally, two lenses facing each other in the first and second lens groups LG1 and LG2 may have opposite refractive powers.

Two lenses adjacent to the region between the first and second lens groups LG1 and LG2 may satisfy the following conditions.

Condition 1: Refractive index of a lens with positive refractive power<Refractive index of a lens with negative refractive power

Condition 2: Dispersion value of a lens with positive refractive power>Dispersion value of a lens with negative refractive power

Accordingly, chromatic aberrations generated between the lenses may be mutually corrected.

The absolute difference between the focal length of the second lens group LG2 and the focal length of the first lens group LG1 may be 5 or more, for example, 10 or more. Accordingly, the optical system 1000 according to the embodiment may have improved aberration control characteristics such as chromatic aberration and distortion aberration by controlling the refractive power and focal length of each lens group LG1 and LG2, and may have good optical performance at the center and periphery portions of the FOV.

In the optical axis OA, the first lens group LG1 and the second lens group LG2 may have a set distance. An optical axis distance between the first lens group LG1 and the second lens group LG2 is a separation distance in the optical axis OA, and may be an optical axis distance between the sensor-side surface the lens closest to the sensor side among the lenses in the first lens group LG1 and the object-side surface of the lens closest to the object side among the lenses in the second lens group LG2. The optical axis distance between the first lens group LG1 and the second lens group LG2 may be greater than a center thickness of the last lens of the first lens group LG1 and greater than a center thickness of the lens positioned first in the second lens group LG2. The optical axis distance between the first lens group LG1 and the second lens group LG2 may be 35% or less of the optical axis distance of the first lens group LG1, and may be, for example, in the range of 15% to 35% or 15% to 25% of the optical axis distance the first lens group LG1. Here, the optical axis distance of the first lens group LG1 is the optical axis distance between the object-side surface of the lens closest to the object-side surface of the first lens group LG1 and the sensor-side surface of the lens closest to the sensor side.

The optical axis distance between the first lens group LG1 and the second lens group LG2 may be 15% or less of the optical axis distance of the second lens group LG2, for example, in a range of 5% to 15% or 5% to 10%. The optical axis distance of the second lens group LG2 is an optical axis distance between the object-side surface of the lens closest to the object-side surface of the second lens group LG2 and the sensor-side surface of the lens closest to the image sensor 300.

The lens with the smallest effective diameter within the first lens group LG1 may be disposed between the lenses of the first lens group LG1. The lens with the smallest effective diameter within the second lens group LG2 may be the lens closest to the first lens group LG1. Here, the size of the effective diameter is an average value of the effective diameter of the object-side surface and the effective diameter of the sensor-side surface of each lens. Accordingly, the optical system 1000 may have good optical performance not only in the center portion of the FOV but also in the periphery portion, and may improve chromatic aberration and distortion aberration.

The size of the lens with the minimum effective diameter in the first lens group LG1 may be smaller than the size of the lens with the minimum effective diameter in the second lens group LG2. The lens surface of the first lens group LG1 includes first to sixth surfaces S1-S6, and the effective diameter of the first to sixth surfaces S1-S6 may gradually decrease from the first surface S1 to the third surface S3, and may gradually increase from the third surface S3 to the sixth surface S6. The lens surface may include an object-side surface and a sensor-side surface of each lens. The lens surface of the second lens group LG2 includes seventh to eighteenth surfaces S7-S18, and the effective diameter of the seventh to eighteenth surfaces S7-S18 may increase from the seventh surface S7 to the eighteenth surface S18. The effective diameter difference between the sixth surface S6 and the seventh surface S7 may be 0.1 mm or less. Accordingly, light may be guided to the periphery portion of the image sensor 300 of about 1 inch by the lens group LG1 and LG2 having different refractive powers and the difference in effective diameter of the lens surfaces.

The effective diameter difference between the lenses having the minimum effective diameter in the first lens group LG1 and the second lens group LG2 may be 0.1 mm or more, for example, in the range of 0.1 mm to 0.3 mm. Accordingly, the incident light may be refracted into the effective region between the first and second lens groups LG1 and LG2, and then refracted to the periphery portion of the image sensor 300.

The lens closest to the object-side surface Among the lenses of the first lens group LG1 may have positive (+) refractive power, and the lens closest to the sensor side among the lenses of the second lens group LG2 may have negative (−) refractive power. In the optical system 1000, the number of lenses with positive (+) refractive power may be greater or smaller than the number of lenses with negative (−) refractive power. In the second lens group LG2, the number of lenses with positive (+) refractive power may be the same as or different from the number of lenses with negative (−) refractive power. For example, in the first embodiment of FIG. 1, the number of lenses with positive (+) refractive power may be greater than the number of lenses with negative (−) refractive power, and their ratio may be 6:3. In the second embodiment of FIG. 5, the number of lenses with positive (+) refractive power may be greater than the number of lenses with negative (−) refractive power, and their ratio may be 5:4. In the third embodiment of FIG. 8, the number of lenses with positive (+) refractive power may be smaller than the number of lenses with negative (−) refractive power, and their ratio may be 4:5. Accordingly, chromatic aberration between the lenses of the second lens group LG2 may be corrected. In addition, the ratio of the number of lenses with positive refractive power to the number of lenses with negative refractive power in the optical system 1000 may be 6:3, 5:4, or 4:5, and chromatic aberration between each lens is corrected.

In the optical system 1000, the sum of focal lengths of lenses with positive refractive power may be smaller than the absolute value of the sum of focal lengths of lenses with negative refractive power. Accordingly, chromatic aberration and resolution may be improved by using the refractive power and positive and negative focal lengths of each lens.

Each of the plurality of lenses may include an effective region and a non-effective region. The effective region may be a region through which light incident on each of the lenses passes. That is, the effective region may be an effective diameter or a region of an effective diameter in which the incident light is refracted to realize optical characteristics. The non-effective region may be arranged around the effective region. The end of the effective region may be defined as an edge or end. The non-effective region may be a region where effective light does not enter the plurality of lenses. That is, the non-effective region may be a region unrelated to the optical characteristics. Additionally, the end of the non-effective region may be a region fixed to a barrel (not shown) that accommodates the lens.

The optical system 1000 may include an image sensor 300. The image sensor 300 may detect light and convert it into an electrical signal. The image sensor 300 may detect light that sequentially passes through the plurality of lenses 100. The image sensor 300 may include an element capable of detecting incident light, such as a charge coupled device (CCD) or a complementary metal oxide semiconductor (CMOS). The diagonal length of the image sensor 300 may be greater than 4 mm, for example, greater than 4 mm and less than 30 mm. Preferably, ImgH of the image sensor 300 may be smaller than TTL.

The optical system 1000 may include an optical filter 500. The optical filter 500 may be disposed between the second lens group LG2 and the image sensor 300. The optical filter 500 may be disposed between the image sensor 300 and a lens closest to the sensor among the lens portions 100, 100A, and 100B. For example, when the optical system 100 is a nine lens, the optical filter 500 may be disposed between the image sensor 300 and the ninth lens 109, which is the last lens.

The optical filter 500 may include an infrared filter. The optical filter 500 may pass light in a set wavelength band and filter light in a different wavelength band. When the optical filter 500 includes an infrared filter, radiant heat emitted from external light may be blocked from being transmitted to the image sensor 300. Additionally, the optical filter 500 may transmit visible light and reflect infrared rays. As another example, a cover glass may be further disposed between the optical filter 500 and the image sensor 300.

The optical system 1000 according to the embodiment may include an aperture stop. The aperture stop may be a stopper that adjusts the amount of light incident on the optical system 1000. The aperture stop may be disposed around at least one lens among the lenses of the first lens group LG1. For example, the aperture stop may be placed around the object-side surface or sensor-side surface of the second or third lens on the object. Alternatively, at least one lens selected from among the plurality of lenses may function as an aperture stop.

The straight distance from the aperture stop to the sensor-side surface of the n-th lens may be smaller than the optical axis distance from the object-side surface of the first lens 101 to the sensor-side surface of the n-th lens. The optical axis distance from the aperture stop to the sensor-side surface of the n-th lens is SD, and the following condition may satisfy: SD<EFL. Additionally, the following condition may satisfy: SD<TTL. EFL is the effective focal length of the entire optical system and may be defined as F. The above condition may satisfy: F<TTL. The difference between F and ImgH may be 2 mm or less, for example, 0.01 mm to 2 mm. The FOV of the optical system 1000 may be less than 120 degrees, for example, more than 70 degrees and less than 100 degrees. The F number (F #) of the optical system 1000 may be greater than 1 but less than 10, for example, in a range of 1.1≤F #≤5. when it is 3 or less, a bright image may be provided. Additionally, the F # may be smaller than the entrance pupil diameter (EPD). Accordingly, the optical system 1000 has a slim size, may control incident light, and may have improved optical characteristics within the FOV.

The optical system 1000 according to the embodiment may further include a reflective member (not shown) to change the path of light. The reflective member may be implemented as a prism that reflects incident light from the first lens group LG1 in the direction of the lenses. Hereinafter, the optical system according to the embodiment will be described in detail.

Hereinafter, descriptions of the first to third embodiments will focus on the first embodiment, and the second and third embodiments will be additionally described with respect to configurations different from the first embodiment.

Referring to FIGS. 1, 5, and 8, in the first to third embodiments, the lens portions 100, 100A, and 100B may include first lenses 101 to ninth lenses 109. The first to ninth lenses 101 to 109 may be sequentially aligned along the optical axis OA of the optical system 1000. Light corresponding to object information may pass through the first to ninth lenses 101 to 109 and the optical filter 500 and be incident on the image sensor 300.

The first lens group LG1 may include the first to third lenses 101 to 103, and the second lens group LG2 may include the fourth to ninth lenses 104 to 109. The optical axis distance between the third lens 103 and the fourth lens 104 may be the optical axis distance between the first and second lens groups LG1 and LG2, and is provided at 0.20 mm or more to suppress an increase in the effective diameters of the fourth lens 104 and the fifth lens 105.

Among the first to ninth lenses 109, the number of lenses having a meniscus shape convex toward the object on the optical axis OA may be 4 or more or 6 or less, and may satisfy, for example, n-4 or n-5 of the total number of lenses n. For example, n may be 9. In the total lenses, the ratio of the meniscus-shaped lens convex toward the object-side surface and the meniscus-shaped lens convex toward the sensor may be either 6:1 or 5:2.

Referring to FIGS. 1, 5, and 8, the first lens 101 may have positive (+) or negative (−) refractive power on the optical axis OA, and may preferably have positive (+) refractive power. The first lens 101 may include plastic or glass. For example, the first lens 101 may be made of plastic.

On the optical axis OA, the object-side first surface S1 of the first lens 101 may have a convex shape, and the sensor-side second surface S2 may have a concave shape. That is, the first lens 101 may have a meniscus shape that is convex toward the object on the optical axis OA. Since the first lens 101 has a meniscus shape that is convex toward the object, the amount of incident light may be improved. Alternatively, the first lens 101 may have a lens shape in which both sides are convex. Alternatively, the first surface S1 may have a concave shape. At least one of the first surface Si and the second surface S2 may be an aspherical surface. For example, both the first surface S1 and the second surface S2 may be aspherical. The aspheric coefficients of the first and second surfaces S1 and S2 are provided as shown in FIGS. 4, 7, and 10, where L1 is the first lens 101, L1S1 is the first surface, and L1S2 is the second surface.

The second lens 102 may have positive (+) or negative (−) refractive power on the optical axis OA. The second lens 102 may have positive refractive power. The second lens 102 may include plastic or glass. For example, the second lens 102 may be made of plastic. Additionally, an aperture stop may be disposed around the fourth surface S4 on the sensor-side surface of the second lens 102.

On the optical axis OA, the object-side third surface S3 of the second lens 102 may have a convex shape, and the sensor-side fourth surface S4 may have a convex shape. That is, the second lens 102 may have a shape in which both sides are convex on the optical axis OA. Alternatively, on the optical axis OA, the third surface S3 may have a convex shape, and the fourth surface S4 may have a concave shape. The third surface S3 and the fourth surface S4 of the second lens 102 may be provided without a critical point from the optical axis OA to the end of the effective region. At least one of the third surface S3 and the fourth surface S4 may be an aspherical surface. For example, both the third surface S3 and the fourth surface S4 may be aspherical. The aspherical coefficients of the third and fourth surfaces S3 and S4 are provided as shown in FIGS. 4, 7, and 10, where L2 is the second lens 102, L2S1 is the third surface, and L2S2 is the fourth surface.

The third lens 103 may have positive (+) or negative (−) refractive power on the optical axis OA, and may preferably have negative (−) refractive power. The third lens 103 may include plastic or glass. For example, the third lens 103 may be made of plastic. The third lens 103 is located on the sensor side of the second lens 102 where the aperture stop is placed and has negative refractive power, and light is refracted in a direction away from the optical axis by the aperture stop, so the third lens located on the sensor side of the aperture may have an effective diameter larger than that of the second lens. The first and second lenses 101 and 102 have positive refractive power, and the third lens 103 has negative refractive power, so that chromatic aberration occurring in lenses made of the same material may be corrected.

On the optical axis OA, the object-side fifth surface S5 of the third lens 103 may have a concave shape, and the sensor-side sixth surface S6 may have a concave shape. That is, the third lens 103 may have a meniscus shape that is convex toward the object on the optical axis OA. Differently, on the optical axis OA, the fifth surface S5 may have a concave shape, and the sixth surface S6 may have a concave shape. The third lens 103 may have a meniscus shape convex toward the object. The fifth surface S5 and the sixth surface S6 of the third lens 103 may be provided without a critical point from the optical axis OA to the end of the effective region. At least one of the fifth surface S5 and the sixth surface S6 may be an aspherical surface. For example, both the fifth surface S5 and the sixth surface S6 may be aspherical. The aspherical coefficients of the fifth and sixth surfaces S5 and S6 are provided as shown in FIGS. 4, 7, and 10, where L3 is the third lens 103, L3S1 is the fifth surface, and L3S2 is the sixth surface.

The fourth lens 104 may have positive (+) or negative (−) refractive power on the optical axis OA. The fourth lens 104 may have negative refractive power. The fourth lens 104 may include plastic or glass. For example, the fourth lens 104 may be made of plastic.

In the first embodiment of FIGS. 1 and 3, the object-side seventh surface S7 of the fourth lens 104 on the optical axis OA has a concave shape, and the sensor-side eighth surface S8 has a convex shape. That is, the fourth lens 104 may have a meniscus shape that is convex toward the sensor on the optical axis OA. Alternatively, the fourth lens 104 may have a convex shape on both sides of the optical axis or a meniscus shape that is convex toward the object. Alternatively, the fourth lens 104 may have a concave shape on both sides.

In the second embodiment of FIGS. 5 and 6, the object-side seventh surface S7 of the fourth lens 104 on the optical axis OA has a convex shape, and the sensor-side eighth surface S8 may have a concave shape. That is, the fourth lens 104 may have a meniscus shape that is convex toward the object on the optical axis OA. Alternatively, the fourth lens 104 may have a convex shape on both sides of the optical axis or a meniscus shape that is convex toward the sensor. Alternatively, the fourth lens 104 may have a concave shape on both sides.

In the third embodiment of FIGS. 8 and 9, the object-side seventh surface S7 of the fourth lens 104 on the optical axis OA has a convex shape, and the sensor-side eighth surface S8 may have a concave shape. That is, the fourth lens 104 may have a meniscus shape that is convex toward the object on the optical axis OA. Alternatively, the fourth lens 104 may have a shape in which both sides is convex on the optical axis or a meniscus shape that is convex toward the sensor. Alternatively, the fourth lens 104 may have a concave shape on both sides.

At least one or both of the seventh and eighth surfaces S7 and S8 of the fourth lens 104 may be provided without a critical point. At least one of the seventh surface S7 and the eighth surface S8 may be an aspherical surface. For example, the seventh surface S7 and the eighth surface S8 may be aspherical, the aspherical coefficients are provided as shown in FIGS. 4, 7, and 10, and L4 is the fourth lens 104, L4S1 is the seventh surface, and L4S2 is the eighth surface. At least one or both of the seventh surface S7 and the eighth surface S8 of the fourth lens 104 may be provided without a critical point.

In the first to third embodiments, the focal length (absolute value) of the fourth lens 104 may be the largest within the lens portion 100. Accordingly, a difference between the focal lengths of the fourth lens 104 and the third lens 103 may be largest within the lens portion 100. For example, the absolute value of the focal length of the fourth lens 104 is |F4|, the absolute value of the focal length of the third lens 103 is |F3|, and the focal length of the fifth lens 105 is F5. In this case, the following condition may satisfy: |F3|<|F5|<F4.

The fifth lens 105 may have positive or negative refractive power on the optical axis OA. In the first embodiment of FIGS. 1 and 3, the fifth lens 105 may have positive refractive power. In the second embodiment of FIGS. 5 and 6, the fifth lens 105 may have positive refractive power. In the third embodiment of FIGS. 8 and 9, the fifth lens 105 may have negative refractive power.

The fifth lens 105 may include plastic or glass. For example, the fifth lens 105 may be made of plastic. Since the first to fifth lenses 101 to 105 include positive and negative refractive powers, chromatic aberration occurring in lenses made of the same material may be corrected.

In the first embodiment of FIGS. 1 and 3, the object-side ninth surface S9 of the fifth lens 105 on the optical axis OA has a concave shape, and the sensor-side tenth surface S10 may have a convex shape. That is, the fifth lens 105 may have a meniscus shape that is convex toward the sensor on the optical axis OA. Alternatively, the fifth lens 105 may have a concave or convex shape on both sides. Alternatively, the fifth lens 105 may have a meniscus shape that is convex toward the object on the optical axis OA.

In the second embodiment of FIGS. 5 and 6, the object-side ninth surface S9 of the fifth lens 105 on the optical axis OA may have a concave shape, and the sensor-side tenth surface S10 may have a convex shape. That is, the fifth lens 105 may have a meniscus shape that is convex toward the sensor on the optical axis OA. Alternatively, the fifth lens 105 may have a concave or convex shape on both sides. Alternatively, the fifth lens 105 may have a meniscus shape that is convex toward the object on the optical axis OA.

In the third embodiment of FIGS. 8 and 9, the object-side ninth surface S9 of the fifth lens 105 at the optical axis OA may have a convex shape, and the sensor-side tenth surface S10 may have a concave shape. That is, the fifth lens 105 may have a meniscus shape that is convex toward the object on the optical axis OA. Alternatively, the fifth lens 105 may have a concave or convex shape on both sides. Alternatively, the fifth lens 105 may have a meniscus shape that is convex toward the sensor on the optical axis OA.

At least one or both of the ninth surface S9 and the tenth surface S10 of the fifth lens 105 may be provided without a critical point. At least one of the ninth surface S9 and the tenth surface S10 may be an aspherical surface. For example, the ninth surface S9 and the tenth surface S10 may be aspherical, the aspherical coefficients are provided as shown in FIGS. 4, 7, and 10, and L5 is the fifth lens 105, L5S1 is the ninth surface, and L5S2 is the tenth surface.

The sixth lens 106 may have positive (+) or negative (−) refractive power on the optical axis OA. In the first embodiment of FIGS. 1 and 3, the sixth lens 106 may have positive refractive power. In the second embodiment of FIGS. 5 and 6, the sixth lens 106 may have positive refractive power. In the third embodiment of FIGS. 8 and 9, the sixth lens 106 may have positive refractive power. The sixth lens 106 may include plastic or glass. For example, the sixth lens 106 may be made of plastic.

In the first embodiment of FIGS. 1 and 3, the object-side eleventh surface S11 of the sixth lens 106 on the optical axis OA has a convex shape, and the sensor-side twelfth surface S12 may have a convex shape. That is, the sixth lens 106 may have a shape in which both sides are convex on the optical axis OA. Alternatively, the sixth lens 106 may have a meniscus shape that is convex toward the sensor on the optical axis. Alternatively, the sixth lens 106 may have a concave shape on both sides. Alternatively, the sixth lens 106 may have a meniscus shape that is convex toward the object.

In the second embodiment of FIGS. 5 and 6, the object-side eleventh surface S11 of the sixth lens 106 on the optical axis OA has a concave shape, and the sensor-side twelfth surface S12 may have a convex shape. That is, the sixth lens 106 may have a meniscus shape that is convex toward the sensor on the optical axis OA. Alternatively, the sixth lens 106 may have a convex or concave shape on both sides of the optical axis. Alternatively, the sixth lens 106 may have a meniscus shape that is convex toward the object.

In the third embodiment of FIGS. 8 and 9, the object-side eleventh surface S11 of the sixth lens 106 on the optical axis OA has a concave shape, and the sensor-side twelfth surface S12 may have a convex shape. That is, the sixth lens 106 may have a meniscus shape that is convex toward the sensor on the optical axis OA. Alternatively, the sixth lens 106 may have a convex or concave shape on both sides of the optical axis. Alternatively, the sixth lens 106 may have a meniscus shape that is convex toward the object.

At least one or both of the eleventh surface S11 and the twelfth surface S12 of the sixth lens 106 may be provided without a critical point from the optical axis OA to the end of the effective region. At least one of the eleventh surface S11 and the twelfth surface S12 may be an aspherical surface. For example, the eleventh surface S11 and the twelfth surface S12 may be aspherical, the aspherical coefficients are provided as shown in FIGS. 4, 7, and 10, and L6 is the sixth lens 106, L6S1 is the eleventh surface, and L6S2 is the twelfth surface.

The seventh lens 107 may have positive (+) or negative (−) refractive power on the optical axis OA and is the n-2th lens. In the first embodiment of FIGS. 1 and 3, the seventh lens 107 may have positive refractive power. In the second embodiment of FIGS. 5 and 6, the seventh lens 107 may have negative refractive power. In the third embodiment of FIGS. 8 and 9, the seventh lens 107 may have positive refractive power. The seventh lens 107 may include plastic or glass. For example, the seventh lens 107 may be made of plastic. Since the fifth to ninth lenses 105, 106, 107, 108, and 109 include positive and negative refractive powers, they may correct chromatic aberration occurring in lenses made of the same material. Additionally, the following condition may satisfy: |F6|<F7.

On the optical axis OA, the object-side thirteenth surface S13 of the seventh lens 107 may have a concave shape, and the sensor-side fourteenth surface S14 may have a concave shape. That is, the seventh lens 107 may have a shape in which both sides are a concave on the optical axis OA. Alternatively, the seventh lens 107 may have a meniscus shape that is convex toward the sensor on the optical axis. Alternatively, the seventh lens 107 may have a convex shape on both sides.

At least one of the thirteenth surface S13 and the fourteenth surface S14 of the seventh lens 107 may be aspherical. For example, the thirteenth surface S13 and the fourteenth surface S14 may be aspherical, the aspherical coefficients are provided as shown in FIGS. 4, 7, and 10, and L7 is the seventh lens 107, L7S1 is the thirteenth surface, and L7S2 is the fourteenth surface.

The eighth lens 108 is the n-1th lens and may have negative or positive refractive power on the optical axis OA, and may have, for example, positive refractive power. The eighth lens 108 may include plastic or glass, and may be made of, for example, plastic.

The eighth lens 108 may include a fifteenth surface S15 defined as the object-side surface and a sixteenth surface S16 defined as the sensor-side surface. On the optical axis OA, the fifteenth surface S15 may have a convex shape, and the sixteenth surface S16 may have a concave shape. That is, the eighth lens 108 may have a meniscus shape that is convex toward the object on the optical axis OA. Alternatively, the eighth lens 108 may have a meniscus shape that is convex toward the sensor on the optical axis or a shape that is concave on both sides.

The fifteenth and sixteenth surfaces S15 and S16 of the eighth lens 108 may have critical points P1 and P2 as shown in FIG. 2. The fifteenth and sixteenth surfaces S15 and S16 may be aspherical, and the aspherical coefficients are provided as shown in FIGS. 4, 7, and 10, L8 is the eighth lens 108, L8S1 is the fifteenth surface, and L8S2 is the sixteenth surface.

As shown in FIG. 2, the first critical point P1 of the fifteenth surface S15 of the eighth lens 108 may be located at a position greater than 79% of the effective radius with respect to the optical axis OA, for example, in the range of 79% to 99%, or in the range of 84% to 94%. The second critical point P2 of the sixteenth surface S16 may be located at a position greater than 72% of the effective radius r82 based on the optical axis OA, for example, in the range of 72% to 92%, or in the range of 77% to 87%. The second critical point P2 may be located at an edge than the first critical point P1, and the separation distance between the first and second critical points P1 and P2 may be 0.9 mm or less. Accordingly, the sixteenth surface S16 may refract the light incident on the fifteenth surface S15 further in the edge direction, thereby reducing the TTL.

Here, the critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface increases as it decreases, or a point where the slope value decreases as it increases.

The ninth lens 109 is the n-th lens and may have negative refractive power on the optical axis OA. The ninth lens 109 may include plastic or glass. For example, the ninth lens 109 may be made of plastic. The ninth lens 109 may be the closest lens or the last lens in the optical system 1000 to the sensor.

The ninth lens 109 may include a seventeenth surface S17 defined as the object-side surface and an eighteenth surface S18 defined as the sensor-side surface. On the optical axis OA, the seventeenth surface S17 may have a convex shape, and the eighteenth surface S18 may have a concave shape. That is, the ninth lens 109 may have a meniscus shape that is convex toward the object on the optical axis OA. Alternatively, the ninth lens 109 may have a meniscus shape that is convex from the optical axis toward the sensor or a shape that is concave on both sides.

At least one or both of the seventeenth and eighteenth surfaces S17 and S18 of the ninth lens 109 may have a critical point. The seventeenth and eighteenth surfaces S17 and S18 may be aspherical, and the aspherical coefficients are provided as shown in FIGS. 4, 7, and 10, L9 is the ninth lens 109, L9S1 is the seventeenth surface, and L9S2 is the eighteenth surface.

As shown in FIG. 2, the third critical point P3 of the seventeenth surface S17 of the ninth lens 109 may be located at a distance of 52% or less of the effective radius based on the optical axis OA, for example, in the range of 32% to 52% or in the range of 37% to 47%. The fourth critical point P4 of the eighteenth surface S18 may be located in the range of 73% or more, for example, in a range of 73% to 93%, or in a range of 78% to 88% of the effective radius r92 based on the optical axis OA. The third critical point P3 may be located closer to the optical axis OA than the first, second, and fourth critical points P1, P2, and P4, and the separation distance between the third and fourth critical points P3 and P4 may be greater than 1 mm. Accordingly, the seventeenth surface S17 refracts light toward the center of the image sensor 300, and the eighteenth surface S18 refracts light toward the periphery portion of the image sensor 300. Accordingly, the TTL of the optical system 1000 may be reduced.

The positions of the critical points P1, P2, P3, and P4 of the eighth and ninth lenses 108 and 109 are preferably positioned to satisfy the above-mentioned range in consideration of the optical characteristics of the optical system 1000. In detail, it is desirable that the position of the critical point satisfies the above-mentioned range for controlling optical characteristics such as chromatic aberration, distortion characteristics, aberration characteristics, and resolution of the optical system 1000. Accordingly, the path of light emitted to the image sensor 300 through the lens may be effectively controlled. Accordingly, the optical system 1000 according to the embodiment may have improved optical characteristics even in the center and peripheral regions of the FOV.

As shown in FIG. 2, the distance from the optical axis OA to the ends of the effective regions of each of the fifteenth surface S15 and the sixteenth surface S16 of the eighth lens 108 is the effective radius, which may be defined as r81 and r82. The distance from the optical axis OA to the ends of the effective regions of each of the seventeenth surface S17 and the eighteenth surface S18 of the ninth lens 109 is the effective radius, and may be defined as r91 and r92.

The distance from the optical axis OA to the critical points P1, P2, P3, and P4 of the fifteenth, sixteenth, seventeenth, and eighteenth S15, S16, S17, and S18 may be defined as follows.

Inf81: Straight distance from the center of the fifteenth surface S15 to the first critical point P1

Inf82: Straight distance from the center of the sixteenth surface S16 to the second critical point P2

Inf91: Straight distance from the center of the seventeenth surface S17 to the third critical point P3

Inf92: Straight distance from the center of the eighteenth surface S18 to the fourth critical point P4

The distance from the center of each lens surface to the critical point may have the following relationship.

$$Inf 81 < Inf 82 \\ Inf 91 < Inf 92 \\ Inf 91 << Inf 81 < Inf 82 < Inf 92 \\ ( Inf 82 - Inf 81 ) < ( Inf 92 - Inf 91 )$$

The effective radii r81, r82, r91, and r92 and the distances Inf81, Inf82, Inf91, and Inf92 to the critical points P1, P2, P3, and P4 may satisfy the following Equations from the optical axis.

$$0.80 \leq Inf 81 / r 81 \leq 0.98 \\ 0.74 \leq Inf 82 / r 82 \leq 0.91 \\ 0.38 \leq Inf 91 / r 91 \leq 0.46 \\ 0.74 \leq Inf 92 / r 92 \leq 0.91$$

The positions of the first and second critical points P1 and P2 may be located 1 mm or more from the optical axis OA, for example, within a range of 1 mm to 3 mm, and the third critical point P3 may be located at a distance of 1.5 mm or less from the optical axis OA, for example, may be located within the range of 0.7 mm to 1.5 mm. The fourth critical point P4 may be located at a position of 2.2 mm or more from the optical axis, for example, within a range of 2.2 mm to 3.2 mm. Accordingly, the eighth and ninth lenses 108 and 109 may refract the incident light toward the center and periphery portions.

On the optical axis,

The curvature radii of the first and second surfaces S1 and S2 of the first lens 101 are L1R1 and L1R2,

The curvature radii of the third and fourth surfaces S3 and S4 of the second lens 102 are L2R1 and L2R2,

The curvature radii of the fifth and sixth surfaces S5 and S6 of the third lens 103 are L3R1 and L3R2,

The curvature radii of the seventh and eighth surfaces S7 and S8 of the fourth lens 104 are L4R1 and L4R2,

The curvature radii of the ninth and tenth surfaces S9 and S10 of the fifth lens 105 are L5R1 and L5R2,

The curvature radii of the eleventh and twelfth surfaces S11 and S12 of the sixth lens 106 are L6R1 and L6R2,

The curvature radii of the thirteenth and fourteenth surfaces S13 and S14 of the seventh lens 107 are L7R1 and L7R2,

The curvature radii of the sixteenth and sixteenth surfaces S15 and S16 of the eighth lens 108 are L8R1 and L8R2,

The curvature radii of the seventeenth and eighteenth surfaces S17 and S18 of the ninth lens 109 may be defined as L9R1 and L9R2. The curvature radii may satisfy at least one of the following conditions 1-9 to improve the aberration characteristics of the optical system.

(L1R1*L1R2)<|L2R2| Condition 1:

(L1R1+L1R2)<(|L2R2|−L2R1) Condition 2:

(L3R1*L3R2)<|L2R2| Condition 3:

|L4R2|<|L4R1|(where 100<|L4R1|,|L4R2|) Condition 4:

|L5R2|<|L5R1|<|L4R2|(where 40<|L5R1|,|L5R2|) Condition 5:

|L6R2|<|L4R1|<|L6R1|(where 1000<|L6R1|) Condition 6:

|L7R1|<|L7R2|<|L2R2|(where L7R1<0) Condition 7:

L8R1*L8R2<(|L7R1|*|L7R2|)(Here, the following condition may satisfy:L8R1<L8R2) Condition 8:

L9R1+L9R2<L8R2 Condition 9:

L9R1*L9R2<L1R1+L1R2 Condition 10:

(L1R1+L1R2+L2R1+L7R2)<|L2R2|(where L2R2<0) Condition 11:

On the optical axis OA, the average curvature radius of any one of the first and ninth lenses 101 and 109 may be the minimum in the optical system, and the difference between the curvature radii of the first and ninth lenses 101 and 109 may be 2 mm or less. The average of the curvature radii (absolute value) of the third and fourth surfaces S3 and S4 of the third lens 103 may be the maximum within the optical system 1000. By setting the curvature radius of each lens, good optical performance may be provided at the focal length of each lens.

The effective diameters of the first to ninth lenses 101-109 may be defined as CA1-CA9. The effective diameter CA9 of the ninth lens 108 may have a maximum effective diameter and may be 6 mm or more. The effective diameter CA9 of the ninth lens 109 is the average of the effective diameters of the object-side surface and the sensor-side surface. The effective diameter CA9 of the ninth lens 109 may be more than twice the curvature radius of the object-side surface S1 of the first lens 101.

On the optical axis,

The effective diameters of the first and second surfaces S1 and S2 of the first lens 101 are CA11 and CA12,

The effective diameters of the third and fourth surfaces S3 and S4 of the second lens 102 are CA21 and CA22,

The effective diameters of the fifth and sixth surfaces S5 and S6 of the third lens 103 are CA31 and CA32,

The effective diameters of the seventh and eighth surfaces S7 and S8 of the fourth lens 104 are CA41 and CA42,

The effective diameters of the ninth and tenth surfaces S9 and S10 of the fifth lens 105 are CA51 and CA52,

The effective diameters of the eleventh and twelfth surfaces S11 and S12 of the sixth lens 106 are CA61 and CA62,

The effective diameters of the thirteenth and fourteenth surfaces S13 and S14 of the seventh lens 107 are CA71 and CA72,

The effective diameters of the fifteenth and sixteenth surfaces S15 and S16 of the eighth lens 108 are CA81 and CA82,

The effective diameters of the seventeenth and eighteenth surfaces S17 and S18 of the ninth lens 109 may be defined as CA91 and CA92. These effective diameters are factors that affect the aberration characteristics of the optical system, and may satisfy at least one of the following conditions.

CA22≤CA31<CA32≤CA12<CA11 Condition 1:

CA51<CA52<CA61<CA62 Condition 2:

CA62<CA72<CA81<CA82<CA91<CA92 Condition 3:

CA31−CA22<CA41−CA32 Condition 4:

CA41+CA42<CA92 Condition 5:

L9R1+L9R2<CA92 Condition 6:

The effective diameter of the lenses may be the smallest for the second lens 102 and the largest for the ninth lens 109. The effective diameter of the fourth surface S4 or the fifth surface S5 may be the minimum, and the effective diameter of the eighteenth surface S18 may be the largest. The effective diameter of the ninth lens 109 is the largest, so that it may effectively refract incident light toward the image sensor 300. Accordingly, the optical system 1000 may have improved chromatic aberration control characteristics, and the vignetting characteristics of the optical system 1000 may be improved by controlling incident light.

In the optical system, the number of lenses with a refractive index exceeding 1.6 may be 2 or more or 3 or more, and may be smaller than the number of lenses with a refractive index of 1.6 or less. In the optical system, the number of lenses of 1.6 or less may be 5 or more or 6 or less. The average refractive index of the first to ninth lenses 101-109 may be 1.50 or more. In the optical system, the number of lenses with an Abbe number greater than 45 may be greater than the number of lenses with an Abbe number of less than 45, for example, 5 or more. The average Abbe number of the first to ninth lenses 101-109 may be 40 or more. By setting the refractive index and Abbe number of each lens, the effect of chromatic aberration may be controlled.

Referring to FIG. 2, back focal length (BFL) is an optical axis distance from the image sensor 300 to the last lens. That is, BFL is a distance in the optical axis between the image sensor 300 and the eighteenth sensor-side surface S18 of the ninth lens 109.

CT8 is a center thickness or optical axis thickness of the eighth lens 108, and ET8 is an end or edge thickness of the effective region of the eighth lens 108. CT9 is a center thickness or optical axis thickness of the ninth lens 109. CG8 is an optical axis distance between the eighth lens 108 and the ninth lens 109. That is, the optical axis distance CG8 between the eighth lens 108 and the ninth lens 109 is a distance between the sixteenth surface S16 and the seventeenth surface S17 in the optical axis OA. In this way, the center thickness of the first to ninth lenses 109 may be defined as CT1 to CT9, and the optical axis distance between the first to ninth lenses may be defined as CG1 to CG8. Additionally, the edge thickness of each lens may be defined as ET1 to ET9. Here, the edge thickness may be the distance in a direction of the optical axis between the effective regions of each lens.

The CG8 may be larger than the optical axis distance between the second and third lenses 102 and 103. The CG8 may be smaller than the center thickness of each of the sixth and eighth lenses 106 and 108. The CG8 may be the largest among the optical axis distances between two adjacent lenses. The CG8 may be 20% or less of the optical axis distance from the first surface S1 of the first lens 101 to the eighteenth surface S18 of the ninth lens 109, for example, in the range of 5% to 20%. Among the first to ninth lenses 101-109, the lens with the maximum center thickness is the ninth lens 109. The center thickness CT1 of the ninth lens 109 may be greater than the center thickness of the second and eighth lenses 102 and 108, and may satisfy the following conditions: CT1<CG8<CT9 and CG8<CT8. A slim optical system with improved optical performance may be provided by the center thickness of the eighth and ninth lenses 108 and 109 and the optical axis distance between the eighth and ninth lenses 108 and 109.

Additionally, the following Equation may satisfy: CG1<CT3<CT2. Accordingly, a difference between the effective diameters CA1, CA2, and CA3 of each of the first to third lenses 101,102, and 103 may be reduced by reducing the center distance CG1 between the first and second lenses 101 and 102. The following Equation may satisfy: CA3-CA2<CA1-CA2.

The center distance CG8 between the eighth lens 108 and the ninth lens 109 is the largest among the center distances between lenses, and at least one of the optical axis distance CG2 between the second and third lenses 102 and 103, the optical axis distance CG4 between the fourth and fifth lenses 104 and 105, or the optical axis distance CG6 between the sixth and seventh lenses 106 and 107 is the minimum among the center distances between the lenses. Here, the center distance CG3 between the third and fourth lenses 103 and 104 is greater than the center distance between other adjacent lenses, and may satisfy, for example, the following conditions: CG1<CG3, CG2<CG3, and CG4<CG3.

The lens with the maximum center thickness may be the last lens, that is, the ninth lens 109, and the lens with the minimum center thickness may be any one of the fourth and fifth lenses 104 and 105, and may be, for example, the fourth lens 104. The center thickness of the second lens 102 may be greater than the center thickness of each of the first, third, fifth, sixth, and seventh lenses.

The maximum center thickness among the lenses 101-109 may be 4 times or less, for example, in a range of 1.5 to 4 times or 2.7 to 3.5 times the minimum center thickness. The number of lenses with a center thickness of less than 0.4 mm among the lenses may be greater than the number of lenses with a center thickness of 0.4 mm or more, and is 5 or more. The average center thickness of the lenses may be less than 0.4 mm. The optical system 1000 having an image sensor 300 with a size of about 1 inch may be provided in a structure with a slim thickness.

The sum of the center thicknesses (CT) of the first to ninth lenses 101-109 is ECT, the sum of the center distances between the first to ninth lenses 101-109 is ECG, and the average of the center thicknesses (CT) of the ninth lens 101-109 is CT_AVER, and any one of the following conditions may be satisfied.

ΣCG<ΣCT Condition 1:

1.2<(ΣCT−ΣCG) Condition 2:

0.32<CT_AVER<0.39 Condition 3:

The difference between the sum ΣCT of the center thicknesses of the first to ninth lenses 101-109 and the sum ECG of the center distances between the first to ninth lenses 101-109 may be 40% or more of the sum ΣCT of the center thickness or 80% or more of the sum ΣCT of the center distances. Accordingly, the optical system 1000 may control incident light and have improved aberration characteristics and resolution.

When defining the focal length of each lens 101-109 as F1-F9, at least one of the following conditions may be satisfied.

F1<|F4| Condition 1:

F2<F1<|F4| Condition 2:

F8<|F5|<|F4| Condition 3:

(F1*2)<|F4| Condition 4:

By adjusting this focal length, resolution may be affected. when the focal length is described as an absolute value, the focal length F4 of the fourth lens 104 may be the largest among the lenses, and the focal length of the second lens 102 or the ninth lens 109 may be the minimum. The maximum focus distance may be 50 times or more than the minimum focus distance. The refractive power of the first to ninth lenses 101-109 may be distributed to minimize chromatic aberration.

When the refractive index of each lens 101-109 is n1-n9 and the Abbe number of each lens 101-109 is v1-v9, the refractive index may satisfy the following condition: n1<n3, and the Abbe number may satisfy the following condition: v1>v3. n1, n2, n4, n5, n8, n9 are less than 1.6 and may have a difference of less than 0.2 from each other, and n3, n6, n7 are more than 1.60. Abbe numbers v1, v2, v4, v5, v8, and v9 may be 45 or more and have a difference of 15 or less from each other, and v3, v6, and v7 may be less than 45, for example, 30 or less. Accordingly, the optical system 1000 may have improved chromatic aberration control characteristics. Preferably, the following condition may satisfy: v3*n3<v1*n1. Additionally, the following condition may satisfy: v3*n3<v2*n2. To minimize chromatic aberration, the refractive index of the third lens 103 may be set relatively high, and the refractive index of the first and second lenses 101 and 102 may be set relatively low. Additionally, in order to minimize chromatic aberration, the Abbe number v3 of the third lens 103 may be set relatively low and the Abbe number v1 and v2 of the first and second lenses 101 and 102 may be set relatively high.

The first to ninth lenses 101 to 109 are made of plastic material and all have an aspherical surface, so that spherical aberration and chromatic aberration may be corrected, and lenses with a high Abbe number and lenses with a low refractive index are appropriately arranged. Thus, a high-resolution small lens optical system may be provided by compensating for chromatic aberration and improving performance between lenses.

The optical system 1000 according to the embodiment disclosed above may satisfy at least one or two of the equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion but also in the periphery portion of the FOV. The optical system 1000 may have improved resolution and may have a slimmer and more compact structure.

Hereinafter, the center thickness of the first to ninth lenses 101-109 may be defined as CT1-CT9, the edge thickness may be defined as ET1-ET8, and the optical axis distance between two adjacent lenses may be defined as the first and second lenses. From the distance between first and second lenses to the distance between the eighth and ninth lenses, it may be defined as CG1 to CG8. The effective diameters of the first to ninth lenses 101-109 may be defined as CA1-CA9, from the effective diameters of the object-side surface and sensor-side surface of the first lens 101 to the object-side surface and the sensor-side surface of the eighth lens 108, it may be defined as CA11, CA12 to CA91, CA92. The unit of the thickness, distance, and effective diameter values is mm.

$$0 < CT 1 / CT 2 < 1 \qquad [ Equation 1 ]$$

In Equation 1, when the center thickness CT1 of the first lens 101 and the center thickness CT2 of the second lens 102 are satisfied, the optical system 1000 may improve aberration characteristics. Preferably, Equation 1 may satisfy: 0.2<CT1/CT2<0.9.

$$0 < CT 3 / ET 3 < 3 \qquad [ Equation 2 ]$$

In Equation 2, when the center thickness CT3 of the third lens 103 and the edge thickness ET3 of the third lens 103 are satisfied, the optical system 1000 may have improved chromatic aberration control characteristics. Preferably, Equation 2 may satisfy: 0<CT3/ET3<1.

$$1 < CT 1 / ET 1 < 2 \qquad [ Equation 2 - 1 ]$$

$$1 < CT 2 / ET 2 < 5 \qquad [ Equation 2 - 2 ]$$

$$CT 1 < CT 2 \qquad [ Equation 2 - 3 ]$$

$$0.8 < CT 4 / ET 4 < 1.8 \qquad [ Equation 2 - 4 ]$$

$$0.8 < CT 5 / ET 5 < 1.5 \qquad [ Equation 2 - 5 ]$$

$$0.5 < CT 6 / ET 6 < 1.5 \qquad [ Equation 2 - 6 ]$$

$$0.8 < CT 7 / ET 7 < 2 \qquad [ Equation 2 - 7 ]$$

$$0.5 < CT 8 / ET 8 < 1.5 \qquad [ Equation 2 - 8 ]$$

$$0 < CT 9 / ET 9 < 1.5 \qquad [ Equation 2 - 9 ]$$

$$0.5 < SD / TD < 1 \qquad [ Equation 2 - 10 ]$$

If the ratio of each of the center thickness CT2-CT9 and each of the edge thickness ET2-ET9 of the second to ninth lenses 102-109 is satisfied in Equations 2-1 to 2-9, the optical system 1000 may have improved chromatic aberration control characteristics. In other words, since the range of the center thickness relative to the edge thickness of each lens 101-109 is set, and the difference between the outermost thickness and the center thickness of each lens is set, distortion aberration may be corrected and a wide-angle image may be obtained. In addition, the difference between the edge thickness and the center thickness of the first lens 101 may be set larger than the difference between the outermost thickness and the center thickness of the last lens 109 to correct the distortion aberration of the light passing to the image sensor 300.

The SD is the optical axis distance from the aperture stop to the sensor-side eighteenth surface S18 of the ninth lens 109, and the TD is the optical axis distance from the object-side first surface S1 of the first lens 101 to the sensor-side eighteenth surface S18 of the ninth lens 109. The aperture stop may be disposed around the periphery of the sensor-side surface of the second lens 102. When the optical system 1000 according to the embodiment satisfies Equation 2-9, the optical system 1000 may correct chromatic aberration.

$$0 < \vert F\_LG1 / F\_LG2 \vert < 1 \qquad [ Equation 2 - 10 ]$$

F_LG1 is the focal length of the first lens group LG1, and F_LG2 is the focal length of the second lens group LG2. When the optical system 1000 according to the embodiment satisfies Equation 2-10, the optical system 1000 may correct chromatic aberration. That is, as the value of Equation 2-10 approaches 1, the distortion aberration may be reduced. Preferably, the following condition may satisfy: 0<|F_LG1|/|F_LG2 I<0.5.

$$10 < TTL / CT\_AVER < 25 \qquad [ Equation 3 ]$$

In Equation 3, CT_AVER is the average of the center thicknesses of the first to ninth lenses 101-109, and when the center thickness of the lenses and total length (TTL) satisfy the above range, a slim optical system may be provided. Preferably, it may satisfy: 12<TTL/CT_AVER<20.

$$1 < TTL / CT\_AVER / n < 3 \qquad [ Equation 3 - 1 ]$$

In Equation 3-1, n is the total number of lenses, and when the center thickness of the lenses and total length (TTL) satisfy the above range compared to the number of lenses, a slim optical system may be provided.

$$CT 2 < ( CT 3 + CT 4 + CT 5 ) < ( 2 * CT 2 ) \qquad [ Equation 3 - 2 ]$$

In Equation 3-2, when the sum of the center thicknesses CT3, CT4, and CT5 of the third, fourth, and fifth lenses 103, 104, and 105 and the center thickness CT2 of the second lens 102 satisfy the above range, the optical system 1000 may have improved chromatic aberration control characteristics. Preferably, the following condition may satisfy: CT1<CT2<CT8.

$$CG 8 < CT 8 \qquad [ Equation 3 - 3 ]$$

In Equation 3-3, when the optical axis distance CG8 between the eighth and ninth lenses 108 and 109 and the center thickness CT8 of the eighth lens satisfy the above range, the optical system 1000 may have improved chromatic aberration control characteristics.

1.60<n3 [Equation 4]

In Equation 4, n3 means the refractive index at the d-line of the third lens 103. When the optical system 1000 according to the embodiment satisfies Equation 4, the optical system 1000 may improve chromatic aberration characteristics.

$$1.5 < n 1 < 1.60 \; 1.5 < n 2 < 1.60 \; 1.5 < n 4 < 1.60 \; 1.5 < n 5 < 1.60 \qquad [ Equation 4 - 1 ]$$

In Equation 4-1, n1, n2, n4, and n5 are the refractive indices at the d-line of the first, second, fourth, and fifth lenses 101, 102, 104, and 105. When the optical system 1000 according to the embodiment satisfies Equation 4-1, the influence on the TTL of the optical system 1000 may be suppressed.

$$0.3 \leq \vert n 7 - n 8 \vert \leq 0.1 \; 0 \leq \vert n 8 - n 9 \vert \leq 0.05 \qquad [ Equation 4 - 2 ]$$

In Equation 4-2, n7, n8, and n9 are the refractive indices at the d-line of the seventh, eighth, and ninth lenses 107, 108, and 109. When the optical system 1000 according to the embodiment satisfies Equation 4-2, the optical system 1000 may improve chromatic aberration characteristics.

$$0 < n 1 / n 3 < 1.5 \qquad [ Equation 5 ]$$

In Equation 5, when the refractive indices n1 and n2 at the d-line of the first and third lenses 101 and 103 satisfy the above range, the optical system may improve the resolution of incident light. Preferably, the following condition may satisfy: 0.5<n1/n3<1.

$$0 < n 3 / n 4 < 1.5 \qquad [ Equation 6 ]$$

In Equation 6, when the refractive indices n3 and n5 at the d-line of the third and fourth lenses 103 and 104 satisfy the above range, the optical system may improve the resolution of the incident light of the second lens group LG2. Preferably, Equation 71 may satisfy: 1<n3/n4<1.5.

$$( v 3 * n 3 ) < ( v 1 * n 1 ) \qquad [ Equation 7 ]$$

In Equation 7, when the refractive index n1 and Abbe number v1 of the first lens 101 and the refractive index n3 and Abbe number v3 of the third lens 103 are satisfied, the color dispersion of light transmitted through the first and third lenses 101 and 103 may be controlled.

$$0 < Inf 91 / Inf 92 < 1 \qquad [ Equation 8 ]$$

In Equation 8, the distance Inf91 from the optical axis OA to the critical point P3 of the seventeenth surface S17 of the ninth lens 109 and the distance Inf92 from the optical axis OA to the critical point P4 of the eighteenth surface S18 may be set, and when this is satisfied, the curvature aberration of the ninth lens 109 may be controlled. Equation 8 may satisfy: 0.2<Inf91/Inf92<0.8.

$$0 < Inf 81 / Inf 82 < 1.5 \qquad [ Equation 9 ]$$

In Equation 9, the distance Inf81 from the optical axis OA to the critical point P1 of the fifteenth surface S15 of the eighth lens 107 and the distance Inf82 from the critical point P2 of the sixteenth surface S16 may be set, and when this is satisfied, the curvature aberration of the eighth lens 108 may be controlled. Equation 9 may satisfy: 0.5<Inf81/Inf82<1.

$$0.5 < Inf 82 / Inf 92 < 1.5 \qquad [ Equation 10 ]$$

When Equation 10 is satisfied, the curvature aberration of the eighth and ninth lenses may be controlled. Equation 10 may satisfy: 0.7<Inf82/Inf92<1.

$$0 < CG 8 / ( CT 8 + CT 9 ) < 1 \qquad [ Equation 11 ]$$

In Equation 11, when the optical axis distance CG8 between the eighth and ninth lenses 108 and 109 is smaller than the sum of the center thicknesses of adjacent lenses, good optical performance may be achieved even in the center and peripheral portions of the FOV. Additionally, the optical system 1000 may reduce distortion and have improved optical performance. Preferably, Equation 11 may satisfy: 0.2<CG8/(CT8+CT9)<0.6.

$$0 < CG 8 / ( CG 5 + CG 6 ) < 3 \qquad [ Equation 12 ]$$

In Equation 12, when the sum of the optical axis distances CG5 and CG6 between the fifth lens 105 to the seventh lens 107 and the optical axis distance CG8 between the eighth and ninth lenses 108 and 109 are satisfied, the optical system 1000 may improve aberration characteristics and control the size of the optical system 1000, for example, reducing the TTL. Preferably, Equation 12 may satisfy: 1<CG8/(CG5+CG6)<1.5.

$$0 < CT 1 / CT 8 < 1.5 \qquad [ Equation 13 ]$$

In Equation 13, when the center thickness CT1 of the first lens 101 and the center thickness CT8 of the eighth lens 108 are satisfied, the optical system 1000 may have improved aberration characteristics. Additionally, the optical system 1000 has good optical performance at a set FOV and may control TTL. Preferably, Equation 13 may satisfy: 0<CT1/CT8<1.

$$0 < CT 7 / CT 8 < 1.5 \qquad [ Equation 14 ]$$

In Equation 14, when the center thickness CT7 of the seventh lens 107 and the center thickness CT8 of the eighth lens 108 are satisfied, the optical system 1000 may reduce the manufacturing precision of the seventh lens 107 and the eighth lens 108, and improve optical performance in the center and periphery portion of the FOV. Preferably, Equation 13 may satisfy: 0.3<CT7/CT8<1.

$$0 < L 8 R 2 / L 9 R 1 < 10 \qquad [ Equation 15 ]$$

In Equation 15, L8R2 means the curvature radius (unit: mm) on the optical axis of the sixteenth surface S16 of the eighth lens 108, and L9R1 means the curvature radius (unit: mm) on the optical axis of the seventeenth surface S17 of the ninth lens 109. When the optical system 1000 according to the embodiment satisfies Equation 14, the aberration characteristics of the optical system 1000 may be improved. Preferably, Equation 15 may satisfy: 0<L8R2/L9R1<5.

$$0 < ( CT 8 - CG 8 ) / ( CT 8 ) < 1 \qquad [ Equation 16 ]$$

When Equation 16 satisfies the center distance CG8 between the eighth and ninth lenses 108 and 109 and the center thickness CT8 of the eighth lens 108, the optical system 1000 may reduce the occurrence of distortion and have improved optical performance. when Equation 16 is satisfied, the optical path traveling through the eighth and ninth lenses 108 and 109 may be set. When the optical system 1000 according to the embodiment satisfies Equation 16, optical performance in the center and peripheral portions of the FOV may be improved. Equation 16 may preferably satisfy: 0<(CT8−CG8)/(CT8)<0.5. Here, when comparing the center distances (CGs) between the sixth, seventh, eighth, and ninth lenses, the following condition may satisfy: CG7<CG6<CG8.

$$0 < CA 11 / CA 32 < 2 \qquad [ Equation 17 ]$$

In Equation 17, CA11 means to the effective diameter (clear aperture: CA) of the first surface S1 of the first lens 101, and CA32 means to the effective diameter of the sixth surface S6 of the third lens 103. When the optical system 1000 according to the embodiment satisfies Equation 17, the optical system 1000 may control the optical path incident and emitted from the first lens group LG1 and have improved aberration control characteristics. Equation 17 may preferably satisfy: 1<CA11/CA32<1.5.

$$1 < CA 92 / CA 31 < 5 \qquad [ Equation 18 ]$$

In Equation 18, CA31 means to the effective diameter of the fifth surface S5 of the third lens 103, and CA92 means to the effective diameter of the eighteenth surface S18 of the ninth lens 109. When the optical system 1000 according to the embodiment satisfies Equation 18, the optical system 1000 may control the path of light incident on the second lens group LG2 and improve aberration characteristics. Preferably, Equation 18 may satisfy: 2<CA92/CA31<3.

$$0.5 < CA 32 / CA 41 < 1.5 \qquad [ Equation 19 ]$$

In Equation 19, when the effective diameter CA32 of the sixth surface S6 of the third lens 103 and the effective diameter CA41 of the seventh surface S7 of the fourth lens 104 are satisfied, the difference between the effective diameters of the two lens groups LG1 and LG2 may be reduced and light loss may be suppressed. Additionally, the optical system 1000 may improve chromatic aberration and control vignetting for optical performance. Preferably, Equation 19 may satisfy: 0.7<CA32/CA41<1.2.

$$0.1 < CA 52 / CA 72 < 2 \qquad [ Equation 20 ]$$

In Equation 20, when the effective diameter CA52 of the tenth surface S10 of the fifth lens 105 and the effective diameter CA72 of the fourteenth surface S14 of the seventh lens 107 are satisfied, a path of light traveling to the second lens group LG2 may be set. Additionally, the optical system 1000 may improve chromatic aberration. Preferably, Equation 20 may satisfy: 0.4<CA52/CA82<1.

$$1 < CA 92 / CA 11 < 5 \qquad [ Equation 21 ]$$

In Equation 21, when the effective diameter CA91 of the eighteenth surface S18 of the ninth lens 109 and the effective diameter CA11 of the first surface S1 of the first lens 101 are satisfied, the effective diameter and optical path between an entrance lens and the last lens may be set. Accordingly, the optical system 1000 may set the FOV and the size of the optical system. Preferably, Equation 21 may satisfy: 2<CA92/CA11<3.5.

$$5 < CA 92 / CG 8 < 15 \qquad [ Equation 21 - 1 ]$$

In Equation 21-1, CA92 is the effective diameter of the largest lens surface and is the effective diameter of the eighteenth surface S18 of the ninth lens 109. When the optical system 1000 according to the embodiment satisfies Equation 20-1, the optical system 1000 may improve aberration characteristics and control TTL reduction. Preferably, Equation 21-1 may satisfy: 8<CA92/CG8<13.

$$3 < CA 82 / CG 8 < 15 \qquad [ Equation 21 - 2 ]$$

Equation 21-2 may set the effective diameter CA82 of the sixteenth surface S16 of the eighth lens 108 and the optical axis distance CG8 between the eighth and ninth lenses 108 and 109. When the optical system 1000 according to the embodiment satisfies Equation 21-2, the optical system 1000 may improve aberration characteristics and control TTL reduction. Preferably, Equation 21-2 may satisfy: 7<CA82/CG8<10.

$$0 < CG 2 / ( CT 2 + CT 3 ) < 1 \qquad [ Equation 22 ]$$

In Equation 22, when the sum of the optical axis distance CG2 between the second and third lenses 102 and 103 and the center thickness of the second and third lenses 102 and 103 is satisfied, the optical system 1000 may reduce chromatic aberration, improve aberration characteristics, and control vignetting for optical performance. Additionally, by designing the center distance between the second and third lenses 102 and 103 to be smaller than the thickness of adjacent lenses, distortion aberration may be corrected. Preferably, Equation 22 may satisfy: 0<CG2/(CT2+CT3)<0.5. The following condition may satisfy: 9<(CG2/(CT2+CT3))*n<3, where n is the total number of lenses.

$$0 < CG 7 / ( CT 7 + CT 8 ) < 1 \qquad [ Equation 23 ]$$

In Equation 23, when the optical axis distance CG7 between the seventh and eighth lenses 107 and 108 and the sum of the center thicknesses of adjacent lenses are satisfied, the optical system may have good optical performance at the center portion of the FOV. Additionally, by designing the edge distance between the seventh and eighth lenses 107 and 108 to be smaller than the center thickness, distortion aberration may be compensated. Preferably, the following condition may satisfy: 0<CG7/(CT7+CT8)<0.5.

$$10 < CG\_Max / CG 8 < 2 \qquad [ Equation 24 ]$$

In Equation 24, CG_Max means the maximum distance among the center distances of the lenses. When the optical system 1000 according to the embodiment satisfies Equation 24, optical performance may be improved in the periphery portion of the FOV, and distortion of aberration characteristics may be suppressed. Preferably, in Equation 24, CG_Max and CG8 may be equal to each other.

$$0 < CT 7 / CG 8 < 1 \qquad [ Equation 25 ]$$

In Equation 25, when the center thickness CT7 of the seventh lens 107 and the optical axis distance CG8 between the eighth and ninth lenses 108 and 109 are satisfied, the optical system 1000 may set the optical axis distance CG8 between the eighth and ninth lenses and the center thickness of the seventh lens 107, and may improve the optical performance of the peripheral portion of the FOV. Preferably, Equation 25 may satisfy: 0<CT7/CG8<0.7.

$$0 < CG 8 / CT 8 < 3 \qquad [ Equation 26 ]$$

In Equation 26, when the center thickness CT8 of the eighth lens 108 and the optical axis distance CG8 between the eighth and ninth lenses 108 and 109 are satisfied, the optical system 1000 may reduce the effective diameter of the eighth and ninth lenses and the distance, and may improve optical performance in the peripheral portion of the FOV. Preferably, Equation 26 may satisfy: 0<CG8/CT8<1.

$$0 < CG 8 / CT 9 < 3 \qquad [ Equation 27 ]$$

In Equation 27, when the center thickness CT9 of the ninth lens 109 and the optical axis distance CG8 between the eighth and ninth lenses 108 and 109 are satisfied, the optical system 1000 may reduce the effective diameter of the ninth lens and the optical axis distance between the eighth and ninth lenses, and may improve optical performance in the peripheral portion of the FOV. Preferably, Equation 27 may satisfy: 0.5<CG8/CT9<1.

$$2 \; 00 < \vert L 5 R 2 \vert / CT 5 \qquad [ Equation 28 ]$$

In Equation 27, when the curvature radius L5R2 of the tenth surface S10 of the fifth lens 105 and the center thickness CT5 of the fifth lens 105 are satisfied, the optical system 1000 may control the refractive power of the fifth lens 105, and may improve the optical performance of light incident on the second lens group LG2. Preferably, Equation 28 may satisfy: 250<|L5R2|/CT5.

$$0 < \vert L 5 R 1 \vert / L 8 R 1 < 100 \qquad [ Equation 29 ]$$

In Equation 29, when the curvature radius L5R1 of the ninth surface S9 of the fifth lens 105 and the curvature radius L8R1 of the fifteenth surface S15 of the eighth lens 108 are satisfied, the optical performance may be improved by controlling the shapes and refractive powers of the fifth and eighth lenses, and the optical performance of the second lens group LG2 may be improved. Preferably, Equation 29 may satisfy: 30<|L5R1|/L8R1<70. Preferably, the following condition may satisfy: L8R1>0.

$$0 < L 1 R 1 / L 1 R 2 < 1 \qquad [ Equation 30 ]$$

Equation 30 may set the curvature radii L1R1 and L1R2 of the object-side first surface S1 and the second surface S2 of the first lens 101, and when these are satisfied, the lens size and resolution may be set. Preferably, Equation 30 may satisfy: 0<L1R1/L1R2<2. Preferably, it may satisfy: L1R1>0 and L1R2>0.

$$0 < \vert L 2 R 2 / L 2 R 1 \vert < 20 \qquad [ Equation 31 ]$$

Equation 31 may set the curvature radii L2R1 and L2R2 of the object-side third surface S3 and the fourth surface S4 of the second lens 102, and when these are satisfied, the resolution of the lens may be determined. Preferably, Equation 30 may satisfy: 5<|L2R2/L2R1|<15. Preferably, it may satisfy: L2R1>0 and L2R2<0. At least one of Equations 29, 30, and 31 may include at least one of Equations 31-1 to 31-6 below, and may determine the resolution of each lens.

$$0 < L 3 R 1 / L 3 R 2 < 10 \qquad [ Equation 31 - 1 ]$$

Preferably, the following condition may satisfy: 1<L3R1/L3R2<5. L3R1, L3R2>0.

$$1 < L 4 R 1 / L 4 R 2 < 20. \qquad [ Equation 31 - 2 ]$$

$$1 < L 5 R 1 / L 5 R 2 < 2. \qquad [ Equation 31 - 3 ]$$

$$300 < \vert L 6 R 1 / L 6 R 2 \vert \qquad [ Equation 31 - 4 ]$$

Preferably, the following condition may satisfy: 500<|L6R1/L6R2|.

$$0 < L 8 R 1 / L 8 R 2 < 1.5 \qquad [ Equation 31 - 5 ]$$

Preferably 0<L8R1/L8R2<1.

$$1 < L 9 R 2 / L 9 R 1 < 5 \qquad [ Equation 31 - 6 ]$$

Preferably, 1.5<L9R2/L9R1<3.

By setting the center distances and edge distances between two adjacent lenses to the above range using Equations 31, 31-1 to 31-6, the distortion aberration of the aberration characteristic may be corrected. The object-side surface of the fourth lens 104 has a concave or convex shape on the optical axis, and the absolute value of the curvature radius may be greater than 100 mm, for example, 500 mm or more.

$$0 < CT\_Max / CG\_Max < 2 \qquad [ Equation 32 ]$$

In Equation 32, when the thickest thickness CT_Max of the center thickness of each of the lenses and the maximum value CG_Max of the air gap or distance in the optical axis between the plurality of lenses satisfies, the optical system 1000 has good optical performance at a set FOV and focal length, and the size of the optical system 1000 may be reduced, and for example, TTL may be reduced. Preferably, Equation 32 may satisfy: 1<CT_Max/CG_Max<1.5.

$$1 < \sum CT / \sum CG < 3 \qquad [ Equation 33 ]$$

In Equation 33, ΣCT means the sum of the center thicknesses (unit: mm) of each of the plurality of lenses, and ECG means the sum of the distances (unit: mm) in the optical axis OA between two adjacent lenses in the plurality of lenses. When the optical system 1000 according to the embodiment satisfies Equation 33, the optical system 1000 has good optical performance at a set FOV and focal length, and the size of the optical system 1000 may be reduced, and for example, TTL may be reduced. Preferably, Equation 33 may satisfy: 1.5<ΣCT/ΣCG<2.5. Accordingly, the optical system may be designed so that the center thickness of each lens is reduced and the distance between adjacent lenses is increased.

$$10 < \sum Index < 20 \qquad [ Equation 34 ]$$

In Equation 34, ΣIndex means the sum of the refractive indices at the d-line of each of the plurality of lenses. When the optical system 1000 according to the embodiment satisfies Equation 34, the TTL of the optical system 1000 may be controlled and improved resolution may be achieved. Here, the average of the refractive indices of the first to ninth lenses 101-109 may be 1.45 or more, for example, in the range of 1.52 to 1.60. Preferably, Equation 34 may satisfy the conditions: 12<ΣIndex<16 and 100<ΣIndex*n, where n is the total number of lenses.

$$10 < \sum Abbe / \sum Index < 50 \qquad [ Equation 35 ]$$

In Equation 35, ΣAbbe means the sum of Abbe numbers of each of the plurality of lenses. When the optical system 1000 according to the embodiment satisfies Equation 35, the optical system 1000 may have improved aberration characteristics and resolution. The average of the Abbe numbers of the first to ninth lenses 101-109 may be 43 or more, for example, in the range of 43 to 47. Preferably, Equation 35 may satisfy: 20<ΣAbbe/ΣIndex<40. Preferably, the following condition may satisfy: 360<(ΣAbbe−ΣIndex).

$$25 < \sum CT * n < 35 \qquad [ Equation 36 ]$$

In Equation 36, when the relationship between the sum of all lens thicknesses and the number of each lens satisfies, the TTL may be reduced. Preferably, the following conditions may satisfy: 10<ΣCG*n<20 and ΣCG<ΣCT.

$$0 < ET\_Max / CT\_Max < 3 \qquad [ Equation 37 ]$$

In Equation 37, CT_Max meass to the thickest thickness (unit: mm) among the center thicknesses of each of the plurality of lenses, and ET_Max means the maximum edge thickness among the lenses, and the optical system 1000 according to the embodiment satisfies Equation 37. In this case, the optical system 1000 has a set FOV and focal length, and may have good optical performance in the periphery portion of the FOV. Preferably, Equation 37 may satisfy: 1<ET_Max/CT_Max<1.5.

$$0.5 < CA 11 / CA\_Min < 2 \qquad [ Equation 38 ]$$

In Equation 38, when the effective diameter CA11 of the first surface S1 of the first lens 101 and the minimum effective diameter CA_Min of the lens surfaces is satisfied, the amount of light incident through the first lens 101 may be controlled, and a slim optical system may be provided while maintaining optical performance. Preferably, Equation 38 may satisfy: 1<CA11/CA_Min<1.5.

$$1 < CA\_Max / CA\_Min < 5 \qquad [ Equation 39 ]$$

In Equation 39, CA_Max means the largest effective diameter among the object-side surfaces and the sensor-side surfaces of the plurality of lenses, and means the largest effective diameter among the effective diameters (unit: mm) of the first to eighteenth surfaces S1-S18. When the optical system 1000 according to the embodiment satisfies Equation 39, the optical system 1000 may provide a slim and compact optical system while maintaining optical performance. Preferably, Equation 39 may satisfy: 2<CA_Max/CA_Min<4.5. Additionally, the following condition may satisfy: 15<(CA_Max/CA_Min)*n<25.

$$1 < CA\_Max / CA\_AVR < 3 \qquad [ Equation 40 ]$$

In Equation 40, the maximum effective diameter CA_Max and the average effective diameter CA_AVR are set among the object-side surfaces and the sensor-side surfaces of the plurality of lenses. when these are satisfied, a slim and compact optical system may be provided. Preferably, Equation 40 may satisfy: 1.5<CA_Max/CA_AVR<2.5.

$$0.1 < CA\_Min / CA\_AVR < 1 \qquad [ Equation 41 ]$$

In Equation 41, the smallest effective diameter CA_Min and average effective diameter CA_AVR may be set among the object-side surface and sensor-side surface of the plurality of lenses, and when these are satisfied, a slim and compact optical system may be provided. Preferably, Equation 41 may satisfy: 0.3<CA_Min/CA_AVR<0.9.

$$0.1 < CA\_Max / ( 2 * ImgH ) < 1 \qquad [ Equation 42 ]$$

In Equation 42, set the largest effective diameter CA_Max among the object-side surface and sensor-side surface of the plurality of lenses and the distance (ImgH) from the center (0.0F) of the image sensor 300 to the diagonal end (1.0F). when this is satisfied, the optical system 1000 has good optical performance in the center and periphery portions of the FOV and may provide a slim and compact optical system. Here, the ImgH may be in the range of 3 mm to 15 mm or 3 mm to 8 mm. Preferably, Equation 42 may satisfy: 0.5<CA_Max/(2*ImgH)<1.

$$0 < F / L 8 R 2 < 5 \qquad [ Equation 43 ]$$

In Equation 43, the total effective focal length F of the optical system 1000 and the curvature radius L8R2 of the sixteenth surface S16 of the eighth lens 108 may be set. when these are satisfied, the optical system 1000 may reduce the size of the optical system 1000, for example, reduce the total track length TTL. Preferably, Equation 43 may satisfy: 0<F/L8R2<1.

Equation 43 may further include Equation 43-1 below.

$$2 < F / F \# < 8 \qquad [ Equation 43 - 1 ]$$

The F # may mean the F number. Preferably, Equation 43-1 may satisfy: 2<F/F #<4.

$$1 < F / L 9 R 2 < 5 \qquad [ Equation 43 - 2 ]$$

Equation 43-2 may set the total effective focal length F of the optical system 1000 and the curvature radius L9R2 of the eighteenth surface S18 of the ninth lens 109. Preferably, Equation 43-2 may satisfy: 2<F/L9R2<4.5.

$$1 < F / L 1 R 1 < 10 \qquad [ Equation 44 ]$$

In Equation 44, the curvature radius L1R1 and the total effective focal length F of the first surface S1 of the first lens 101 may be set, and when these are satisfied, the optical system 1000 may be reduced in size, for example, TTL. Preferably, Equation 44 may satisfy: 1<F/L1R1<5.

$$0 < EPD / L 9 R 2 < 10 \qquad [ Equation 45 ]$$

In Equation 45, EPD means to the entrance pupil diameter (unit: mm) of the optical system 1000, and L9R2 means to the curvature radius (unit: mm) of the eighteenth surface S18 of the ninth lens 109. When the optical system 1000 according to the embodiment satisfies Equation 45, the optical system 1000 may control the overall brightness and have good optical performance in the center and periphery portions of the FOV. Preferably, Equation 45 may satisfy: 1<EPD/L9R2<3. Equation 45 may further include Equation 45-1 below.

$$1 \leq EPD / F \# < 3 \qquad [ Equation 45 - 1 ]$$

$$0 < EPD / L 1 R 1 < 10 \qquad [ Equation 46 ]$$

Equation 46 represents the relationship between the entrance pupil diameter of the optical system and the curvature radius of the first surface S1 of the first lens 101, and incident light may be controlled. Preferably, Equation 46 may satisfy: 0.5<EPD/L1R1<1.

$$0 < F 1 / F 2 < 50 \qquad [ Equation 47 ]$$

In Equation 47, the focal lengths F1 and F2 of the first and second lenses 101 and 102 may be set. Accordingly, resolution may be improved by adjusting the refractive power of the incident light of the first and second lenses 101 and 102, and TTL may be controlled. Preferably, the following conditions may satisfy: F1>0 and F2>0.

$$0 < F 13 / F < 5 \qquad [ Equation 48 ]$$

In Equation 48, when setting the composite focal length F13 and the total focal length F of the first to third lenses, the optical system 1000 may improve resolution by adjusting the refractive power of the incident light, and may control the TTL of the optical system 1000. Preferably, Equation 48 may satisfy: 1<F13/F<3.

$$0 < \vert F 49 / F 14 \vert < 10 \qquad [ Equation 49 ]$$

In Equation 49, the composite focal length F13 of the first to third lenses, that is, the focal length (unit: mm) of the first lens group, and the composite focal length F49 of the fourth to ninth lenses, that is, a focal length of the second lens group may be set, and when this is satisfied, the refractive power of the first lens group and the refractive power of the second lens group may be controlled to improve resolution, and the optical system may be provided in a slim and compact size. Additionally, when Equation 49 is satisfied, the optical system 1000 may improve aberration characteristics such as chromatic aberration and distortion aberration. Preferably, Equation 49 may satisfy: 3<|F49/F13|<6. Here, the following condition may satisfy: F13>0 and F49<0.

$$F 13 + F 2 < \vert F 49 \vert \qquad [ Equation 49 - 1 ]$$

In Equation 49-1, F13 is the composite focal length of the first to third lenses and may have positive refractive power, and F49 is the composite focal length of the fourth to ninth lenses and may have positive refractive power. When Equation 49-1 is satisfied, the optical system 1000 may improve aberration characteristics such as chromatic aberration and distortion aberration.

$$0 < F 1 / F < 40 \qquad [ Equation 50 ]$$

In Equation 50, the total focal length F and the focal length of the first lens 101 may be set, and resolution may be improved. Equation 50 may satisfy: 10<F1/F<20, and satisfies the following condition may satisfy: F1>0.

$$0 < F 2 / F < 5 ( here , F 2 > 0 \qquad [ Equation 5 - 1 ]$$

$$0 < \vert F 3 / F 2 \vert < 10 ( where F 3 < 0 ) \qquad [ Equation 5 - 2 ]$$

$$50 < \vert F 4 / F \vert < 150 ( where F 4 < 0 ) \qquad [ Equation 5 - 3 ]$$

$$20 < \vert F 5 / F \vert < 150 ( where F 5 < 0 or F 5 < 0 ) \qquad [ Equation 5 - 4 ]$$

$$10 < \vert F 6 / F \vert < 40 ( where F 6 < 0 or F 6 < 0 ) \qquad [ Equation 5 - 5 ]$$

$$0 < \vert F 7 \vert / F < 3 ( where F 7 < 0 or F 7 < 0 ) \qquad [ Equation 5 - 6 ]$$

$$0 < F 8 / F < 10 ( here , F 8 > 0 \qquad [ Equation 5 - 7 ]$$

$$0 < \vert F 9 \vert / F < 2 ( where F 9 < 0 ) \qquad [ Equation 5 - 8 ]$$

$$- 0.5 < F 9 / F 1 < 0 \qquad [ Equation 5 - 9 ]$$

In equations 50-1 to 50-9, F3, F4, F5, F6, F7, F8, and F9 mean the third, fourth, fifth, sixth, seventh, eighth, and ninth lenses 103, 104, 105, 106, 107, 108, and 109 mean the focal length (unit: mm), when this is satisfied, resolution may be improved by controlling the refractive power of each lens, and the optical system may be provided in a slim and compact size. The focal length of each lens may be distributed to advantageously correct chromatic aberration.

$$5 < F 1 / F 13 < 40 \qquad [ Equation 51 ]$$

By setting the focal length F1 of the first lens and the composite focal length F12 of the first to third lenses in Equation 51, the resolution of the first lens group may be adjusted. Preferably, the following condition may satisfy: F13<F1.

$$1 < \vert F 1 / F 49 \vert < 10 \qquad [ Equation 52 ]$$

In Equation 52, the focal length F1 of the first lens and the composite focal length F49 of the fourth to ninth lenses may be set, the size and resolution of the optical system may be adjusted. Preferably, it may satisfy: 0>F49.

$$0 < \vert F 1 / F 4 \vert < 1 \qquad [ Equation 53 ]$$

In Equation 53, the focal length F1 of the first lens and the focal length F4 of the fourth lens may be set, the refractive power of light incident on the first and second lens groups may be controlled, and the size and resolution of the optical system may be adjusted. Preferably, Equation 53 may satisfy: 0<F1/F4|<0.7, and F4<0.

$$2 mm < TTL < 20 mm \qquad [ Equation 54 ]$$

In Equation 54, TTL (Total Track Length) means the distance (unit: mm) in the optical axis OA from the apex of the first surface S1 of the first lens 101 to the upper surface of the image sensor 300. Preferably, Equation 54 satisfies: 3<TTL<12 or TTL<6.5, and thus a slim and compact optical system may be provided.

$$2 mm < ImgH \qquad [ Equation 55 ]$$

Equation 55 sets the diagonal size (2*ImgH) of the image sensor 300 to exceed 4 mm, thereby providing an optical system with high resolution. Equation 55 may preferably satisfy: 4≤ImgH≤15 or 4≤ImgH≤8.

Equation 55 may include at least one of the following equations 55-1 to 55-8.

$$0 < \sum CT / ImgH < 1 \qquad [ Equation 55 - 1 ]$$

$$2 < \sum CT / ImgH < 5 \qquad [ Equation 55 - 2 ]$$

$$2 < \sum Index / ImgH < 5 \qquad [ Equation 55 - 3 ]$$

$$70 < \sum Abbe / ImgH < 110 \qquad [ Equation 55 - 4 ]$$

$$( \sum CT / n ) > ( \sum CT / ImgH ) \qquad [ Equation 55 - 5 ]$$

$$( \sum CG / n ) > ( \sum CG / ImgH ) \qquad [ Equation 55 - 6 ]$$

$$( \sum Index / n ) > ( \sum Index / ImgH ) \qquad [ Equation 55 - 7 ]$$

$$( \sum Abbe / n ) > ( \sum Abbe / ImgH ) \qquad [ Equation 55 - 8 ]$$

Equations 55-1 to 55-8 may establish the relationship between ImgH and the sum of the center thicknesses of all lenses, the sum of the center distance between lenses, the sum of refractive indices of all lenses, the sum of Abbe numbers of all lenses, and the number of total lenses. Accordingly, the resolution and size of the optical system with an ImgH of 4 mm or 6 mm or more may be adjusted.

$$BFL < 2.5 mm \qquad [ Equation 56 ]$$

Equation 56 may secure the installation space of the filter 500 by making the back focal length (BFL) less than 2.5 mm, improve the assembly of components and improve coupling reliability through the gap between the image sensor 300 and the last lens. Equation 56 may preferably satisfy: 0.8<BFL<2.

$$2 mm < F < 20 mm \qquad [ Equation 57 ]$$

In Equation 57, the total focal length F may be set to suit the optical system, and preferably, may satisfy: 4<F<12.

$$FOV < 120 degrees \qquad [ Equation 58 ]$$

In Equation 58, FOV (Field of view) means to the angle (Degree) of view of the optical system 1000, and may provide an optical system of less than 120 degrees. The following condition may satisfy: FOV>70, or the FOV may be in the range of 70 degrees to 100 degrees.

$$0.1 < TTL / CA\_Max < 2 \qquad [ Equation 59 ]$$

In Equation 59, a slim and compact optical system may be provided by setting the largest effective diameter CA_Max among the object and sensor sides of the plurality of lenses and TTL. Preferably, Equation 59 may satisfy: 0.5<TTL/CA_Max<1.

$$0.5 < TTL / ImgH < 3 \qquad [ Equation 60 ]$$

Equation 60 may set the total optical axis length (TTL) of the optical system and the diagonal length (ImgH) from the optical axis of the image sensor 300. When the optical system 1000 according to the embodiment satisfies Equation 60, the optical system 1000 may have a smaller back focal length (BFL) for applying a relatively large image sensor 300, for example, a large image sensor 300 of around 1 inch, and thus may have a high-definition implementation and a slim structure. Preferably, Equation 60 may satisfy the conditions: 1<TTL/ImgH<2 or 0.5<TTL/(2*ImgH)<0.9. Preferably, the following condition may satisfy: ImgH<TTL and 20<TTL*ImgH<30.

$$0.01 < BFL / ImgH < 0.5 \qquad [ Equation 61 ]$$

Equation 61 may set the optical axis distance between the image sensor 300 and the last lens and the diagonal length from the optical axis of the image sensor 300. When the optical system 1000 according to the embodiment satisfies Equation 61, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV. Preferably, Equation 61 may satisfy: 0.1<BFL/ImgH<0.4.

$$4 < TTL / BFL < 10 \qquad [ Equation 62 ]$$

Equation 62 may set (unit, mm) the total optical axis length (TTL) of the optical system and the optical axis distance (BFL) between the image sensor 300 and the last lens. When the optical system 1000 according to the embodiment satisfies Equation 62, the optical system 1000 secures BFL and may be provided in a slim and compact manner. Equation 62 may satisfy: 4<TTL/BFL<7.

$$0.5 < F / TTL < 1.5 \qquad [ Equation 63 ]$$

Equation 63 may set the total focal length F and total optical axis length (TTL) of the optical system 1000. Accordingly, a slim and compact optical system may be provided. Equation 63 may preferably satisfy: 0.5<F/TTL<1.2.

$$0 < F \# / TTL < 0.5 \qquad [ Equation 63 - 1 ]$$

Equation 63-1 may set the F number (F #) and total optical axis length (TTL) of the optical system 1000. Accordingly, a slim and compact optical system may be provided. Here, the following condition may satisfy: F #<2.3, so the brightness may be controlled.

$$3 < F / BFL < 10 \qquad [ Equation 64 ]$$

Equation 64 may set the total focal length F of the optical system 1000 and the optical axis distance BFL between the image sensor 300 and the last lens. When the optical system 1000 according to the embodiment satisfies Equation 64, the optical system 1000 may have a set FOV and an appropriate focal length, and a slim and compact optical system may be provided. Additionally, the optical system 1000 may minimize the gap between the last lens and the image sensor 300 and thus have good optical characteristics in the peripheral area of the FOV. Preferably, Equation 64 may satisfy: 3<F/BFL<7.

$$0 < F / ImgH < 3 \qquad [ Equation 65 ]$$

Equation 65 can set the total focal length F (unit: mm) of the optical system 1000 and the diagonal length (ImgH) from the optical axis of the image sensor 300. This optical system 1000 uses a relatively large image sensor 300, for example, around 1 inch, and may have improved aberration characteristics. Preferably, Equation 65 may satisfy: 0.8<F/ImgH<1.5.

$$1 < F / EPD < 5 \qquad [ Equation 66 ]$$

Equation 66 can set the total focal length F and entrance pupil diameter (EPD) of the optical system 1000. Accordingly, the overall brightness of the optical system may be controlled. Preferably, Equation 66 may satisfy: 1.5<F/EPD<3.

$$0 < BFL / TD < 0.5 \qquad [ Equation 67 ]$$

In Equation 67, the optical axis distance BFL between the image sensor 300 and the last lens and the optical axis distance (TD) of the lenses are set. when this is satisfied, the optical system 1000 may provide a slim and compact optical system. Preferably, Equation 67 may satisfy: 0<BFL/TD<0.3. When BFL/TD exceeds 0.3, since the BFL is designed to be larger than TD, the size of the entire optical system increases, making it difficult to miniaturize the optical system, and the amount of unnecessary light may increase between the image sensor and the image sensor, which causes a problem in that resolution is lowered, such as aberration characteristics are deteriorated.

$$0 < EPD / ImgH / FOV < 0.2 \qquad [ Equation 68 ]$$

In Equation 68, the relationship between the EPD, the length (ImgH) of half the maximum diagonal length of the image sensor, and the FOV may be set. Accordingly, the overall size and brightness of the optical system may be controlled. Equation 68 may preferably satisfy: 0<EPD/ImgH/FOV<0.01.

$$10 < FOV / F \# < 55 \qquad [ Equation 69 ]$$

Equation 69 may establish the relationship between the FOV of the optical system and the F number. Equation 69 may preferably satisfy: 30<FOV/F #<40.

$$15 < ( TD\_LG 2 / TD\_LG 1 ) * n < 30 \qquad [ Equation 70 ]$$

Equation 70 may be set according to the total number of lenses for the optical axis distance TD_LG1 of the first lens group and the optical axis distance TD_LG2 of the second lens group.

$$5 < ( CT\_Max + CG\_Max ) * n < 20 \qquad [ Equation 71 ]$$

Equation 71 may be set according to the number of lenses for the maximum center thickness of the lenses and the maximum distance between adjacent lenses.

$$40 < ( FOV * TTL ) / n < 100 \qquad [ Equation 72 ]$$

Equation 72 may be set according to the number (n) of lenses for the FOV and total length of the optical system, and preferably satisfies the following condition may satisfy: 40<(FOV*TTL)/n<70.

$$( TTL * n ) < FOV \qquad [ Equation 73 ]$$

$$200 < CA\_Max * TD * n < 400 \qquad [ Equation 74 ]$$

$$5 < ( TD / CA\_Max ) * n < 15 \qquad [ Equation 75 ]$$

In Equation 75, TD is the maximum optical axis distance (unit: mm) from the object-side surface of the first lens to the sensor-side surface of the last lens. For example, TD is the distance from the first surface S1 of the first lens 101 to the eighteenth surface S18 of the ninth lens 108 in the optical axis OA. When the optical system 1000 according to the embodiment satisfies Equation 75, a slim and compact optical system may be provided. Preferably, the following condition may satisfy: 0.5<TD/CA_Max<1.5.

$$15 < ( ( CA 92 / CA 41 ) / ( CA 11 / CA 32 ) ) * n < 25 \qquad [ Equation 76 ]$$

In Equation 76, the ratio of the effective diameter CA41 of the object-side surface and the effective diameter CA91 of the sensor-side surface of the second lens group, and the ratio of the effective diameter CA11 of the object-side surface and the effective diameter CA32 of the sensor-side surface of the first lens group may be set according to the total number of lenses. According to Equations 70 to 76, the chromatic aberration, resolution, size, etc. of an optical system with 10 or less lenses may be controlled.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 77 ]$$

In Equation 77, Z is Sag and can mean the distance in the optical axis direction from any position on the aspherical surface to the vertex of the aspherical surface. The Y may refer to the distance from any position on the aspherical surface to the optical axis in a direction perpendicular to the optical axis. The c may refer to the curvature of the lens, and K may refer to the Conic constant. Additionally, A, B, C, D, E, and F may mean aspheric constants.

The optical system 1000 according to the embodiment may satisfy at least one or two or more of Equations 1 to 76. In this case, the optical system 1000 may have improved optical characteristics. In detail, when the optical system 1000 satisfies at least one or two or more of Equations 1 to 76, the optical system 1000 has improved resolution and may improve aberration and distortion characteristics. In addition, the optical system 1000 can secure a BFL for applying the large-size image sensor 300, and may minimize the distance between the last lens and the image sensor 300, and thus have good optical performance in the center and periphery portions of the FOV. In addition, when the optical system 1000 satisfies at least one of Equations 1 to 76, it may include a relatively large image sensor 300, have a relatively small TTL value, and may provide a slimmer and more compact optical system and a camera module having the same.

FIGS. 3, 6 and 9 are examples of lens data of an optical system according to the first to third embodiments.

As shown in FIGS. 3, 6, and 9, the optical system according to the first to third embodiments shows the curvature radius on the optical axis OA of the first to ninth lenses 101-109, the center thickness CT of each lens, the center distance CG between two adjacent lenses, the refractive index at d-line (588 nm), Abbe Number, effective radius (Semi-Aperture), and focus length.

The sum of the refractive indices of the plurality of lenses 100 is greater than 10, the Abbe sum is 300 or more, for example, in the range of 300 to 450, and the sum of the center thicknesses of all lenses is 4 mm or less, for example, in the range of 2 mm to 4 mm. The sum of the center distance between the first to ninth lenses on the optical axis is 3 mm or less, for example, in the range of 1 mm to 3 mm. The difference between the sum of the center thicknesses and the sum of the center distances of the lenses may be 1 mm or more. In addition, the average value of the effective diameter of each lens surface of the plurality of lenses 100 is 5 mm or less, for example, in the range of 2 mm to 5 mm. The average center thickness of each lens may be 0.5 mm or less, for example, in the range of 0.2 mm to 0.5 mm. The sum of the effective diameters of each lens surface of the plurality of lenses 100 is the effective diameter of the first surface S1 to the sixteenth surface S16, and may be less than 100 mm, for example, in the range of 50 mm to 80 mm.

In the first embodiment of FIG. 3, a lens having the maximum value of the focal lengths is the fifth lens 105, a lens having the minimum value of the focal lengths is the fourth lens 104, a lens surface having the maximum value among the curvature radii is the object-side surface L6S1 of the sixth lens 106, and a lens surface having the minimum value of the curvature radii is the object-side surface L4S1 of the fourth lens 104. In the second embodiment of FIG. 6, a lens having the maximum value of the focal lengths is the fifth lens 105, a lens having the minimum value of the focal lengths is the fourth lens 104, a lens surface having the maximum value among the curvature radii is the object-side surface L4S1 of the fourth lens 104, and a lens surface having the minimum value of the curvature radii is the object-side surface L6S1 of the sixth lens 106. In the third embodiment of FIG. 9, a lens having the maximum value of the focal lengths is the first lens, a lens having the minimum value of the focal lengths is the fourth lens or the fifth lens, a lens surface having the maximum value among the curvature radii is the object-side surface L4S1 of the fourth lens 104, and a lens surface having the minimum value among the curvature radii is the object-side surface L6S1 of the sixth lens 106. In the first to third embodiments, when expressing absolute values, the lens with the maximum focal length is the fourth lens, and the lens surface with the maximum curvature radius is the object-side surface L6S1 of the sixth lens 106.

As shown in FIGS. 4, 7, and 10, the lens surface of at least one or all of the plurality of lenses in the embodiment may include an aspherical surface with a 30th order aspheric coefficient. For example, the first to ninth lenses 101-109 may include lens surfaces having a 30th order aspheric coefficient from the first surface Si to the eighteenth surface S18. As described above, an aspheric surface with a 30th order aspheric coefficient (a value other than “0”) can particularly significantly change the aspherical shape of the peripheral portion, so the optical performance of the peripheral area of the FOV may be well corrected.

Table 1 shows the items of the above-described equations in the optical system 1000 according to the embodiment, and relates TTL of the optical system 1000, BFL, and F value, which is the total effective focal length,, ImgH, the focal length F1, F2, F3, F4, F5, F6, F7, F8, and F9 of each of the first to ninth lenses, edge thickness, edge distance, composite focal length, etc.

TABLE 1

| Items | Embodiment1 | Embodiment2 | Embodiment3 |
|---|---|---|---|
| F | 5.000 | 5.020 | 5.000 |
| F1 | 72.700 | 620.270 | 185.000 |
| F2 | 9.790 | 3.960 | 4.100 |
| F3 | −6.090 | −10.370 | −11.180 |
| F4 | −324.080 | −7,590.210 | −624.000 |
| F5 | 186.110 | 391.840 | −617.560 |
| F6 | −26.350 | 19.610 | 19.320 |
| F7 | 7.000 | −5.320 | −5.350 |
| F8 | 21.250 | 4.690 | 4.710 |
| F9 | −4.630 | −6.870 | −6.880 |
| F13 | 5.931 | 5.929 | 5.881 |
| F49 | −25.911 | −25.284 | −21.855 |
| ET1 | 0.267 | 0.267 | 0.265 |
| ET2 | 0.206 | 0.204 | 0.203 |
| ET3 | 0.376 | 0.377 | 0.372 |
| ET4 | 0.200 | 0.201 | 0.202 |
| ET5 | 0.201 | 0.202 | 0.212 |
| ET6 | 0.256 | 0.256 | 0.254 |
| ET7 | 0.269 | 0.267 | 0.253 |
| ET8 | 0.625 | 0.620 | 0.651 |
| ET9 | 0.837 | 0.795 | 0.763 |
| Inf81 | 1.72 | 1.72 | 1.72 |
| Inf82 | 2.07 | 2.06 | 2.13 |
| Inf91 | 1.18 | 1.18 | 1.15 |
| Inf92 | 2.74 | 2.71 | 2.56 |
| FOV | 75.800 | 75.800 | 75.800 |
| EPD | 2.275 | 2.275 | 2.293 |
| BFL | 1.090 | 1.090 | 1.100 |
| TD | 5.088 | 5.100 | 5.050 |
| ImgH | 4.100 | 4.100 | 4.100 |
| SD | 4.031 | 4.040 | 4.000 |
| TTL | 6.160 | 6.160 | 6.170 |
| F# | 2.200 | 2.200 | 2.200 |

Table 2 shows the result values for Equations 1 to 42 described above in the optical system 1000 of FIG. 1. Referring to Table 2, it may be seen that the optical system 1000 satisfies at least one, two, or three of Equations 1 to 42. In detail, it may be seen that the optical system 1000 according to the embodiment satisfies all of the above equations 1 to 42. Accordingly, the optical system 1000 may improve optical performance and optical characteristics in the center and periphery portions of the FOV.

TABLE 2

| | | Embodi- | Embodi- | Embodi- |
|---|---|---|---|---|
| Equations | | ment1 | ment2 | ment3 |
| 1 | 0 < CT1/ | 0.622 | 0.623 | 0.635 |
| | CT2 < 1 | | | |
| 2 | 0 < CT3/ | 0.614 | 0.610 | 0.618 |
| | ET3 < 3 | | | |
| 3 | 10 < TTL/ | 16.325 | 16.306 | 16.429 |
| | CT_ | | | |
| | AVER < 25 | | | |
| 4 | 1.60 < n3 | 1.680 | 1.680 | 1.680 |
| 5 | 0 < n1/ | 0.923 | 0.923 | 0.923 |
| | n3 < 1.5 | | | |
| 6 | 0 < n3/ | 1.084 | 1.084 | 1.084 |
| | n4 < 1.5 | | | |
| 7 | (v3*n3) < | Satis- | Satis- | Satis- |
| | (v1*n1) | faction | faction | faction |
| 8 | 0 < Inf91/ | 0.431 | 0.435 | 0.449 |
| | Inf92 < 1 | | | |
| 9 | 0 < Inf81/ | 0.831 | 0.835 | 0.808 |
| | Inf82 < 1.5 | | | |
| 10 | 0.5 < Inf82/ | 0.755 | 0.760 | 0.832 |
| | Inf92 < 1 | | | |
| 11 | 0 < CG8/ | 0.432 | 0.426 | 0.434 |
| | (CT8 + | | | |
| | CT9) < 1 | | | |
| 12 | 0 < CG8/ | 1.245 | 1.222 | 1.273 |
| | (CG 5 + | | | |
| | CG6) < 3 | | | |
| 13 | 0 < CT1/ | 0.523 | 0.524 | 0.524 |
| | CT8 < 1.5 | | | |
| 14 | 0 < CT7/ | 0.516 | 0.508 | 0.492 |
| | CT8 < 1.5 | | | |
| 15 | 0 < L8R2/ | 1.920 | 1.920 | 1.845 |
| | L9R1 < 10 | | | |
| 16 | (CG8 − CT8)/ | −0.132 | −0.145 | 0.111 |
| | (CG8) < 0 | | | |
| 17 | 0 < CA11/ | 1.250 | 1.250 | 1.253 |
| | CA32 < 2 | | | |
| 18 | 1 < CA92/ | 2.730 | 2.746 | 2.695 |
| | CA41 < 5 | | | |
| 19 | 0.5 < CA32/ | 1.000 | 0.998 | 0.999 |
| | CA41 < 1.5 | | | |
| 20 | 0.1 < CA52/ | 0.774 | 0.767 | 0.775 |
| | CA72 < 2 | | | |
| 21 | 1 < CA92/ | 2.184 | 2.199 | 2.153 |
| | CA11 < 5 | | | |
| 22 | 0 < CG2/ | 0.132 | 0.132 | 0.133 |
| | (CT2 + | | | |
| | CT3) < 1 | | | |
| 23 | 0 < CG7/ | 0.146 | 0.147 | 0.128 |
| | (CT7 + | | | |
| | CT8) < 1 | | | |
| 24 | 0 < CG_ | 1.000 | 1.000 | 1.000 |
| | Max/ | | | |
| | CG8 < 2 | | | |
| 25 | 0 < CT7/ | 0.584 | 0.582 | 0.554 |
| | CG8 < 1 | | | |
| 26 | 0 < CG8/ | 0.883 | 0.873 | 0.889 |
| | CT8 < 3 | | | |
| 27 | 0 < CG8/ | 0.846 | 0.833 | 0.848 |
| | CT9 < 3 | | | |
| 28 | 200 < | −326.814 | −328.500 | 328.500 |
| | IL5R21/ | | | |
| | CT5 | | | |
| 29 | 0 < | 45.798 | 45.514 | 39.646 |
| | IL5R11/ | | | |
| | L8R1 < 100 | | | |
| 30 | 0 < L1R1/ | 1.036 | 1.040 | 1.020 |
| | L1R2 < 3 | | | |
| 31 | 0 < IL2R2/ | 11.487 | 11.491 | 14.389 |
| | L2R11 < 20 | | | |
| 32 | 0 < CT_ | 1.182 | 1.200 | 1.179 |
| | Max/CG_ | | | |
| | Max < 2 | | | |
| 33 | 1 < ΣCT/ | 2.007 | 2.000 | 2.024 |
| | ΣCG < 3 | | | |
| 34 | 10 < | 14.240 | 14.240 | 14.240 |
| | ΣIndex < 20 | | | |
| 35 | 10 < ΣAbbe/ | 28.678 | 28.678 | 28.678 |
| | ΣIndex < 50 | | | |
| 36 | 25 < | 30.564 | 30.600 | 30.420 |
| | ΣCT*n < 35 | | | |
| 37 | 0 < ET_ | 1.278 | 1.205 | 1.156 |
| | Max/CT_ | | | |
| | Max < 3 | | | |
| 38 | 0.5 < CA11/ | 1.364 | 1.364 | 1.361 |
| | CA_Min < 2 | | | |
| 39 | 1 < CA_Max/ | 2.979 | 3.001 | 2.930 |
| | CA_Min < 5 | | | |
| 40 | 1 < CA_Max/ | 2.004 | 2.010 | 1.983 |
| | CA_AVR < 3 | | | |
| 41 | 0.1 < CA_Min/ | 0.673 | 0.670 | 0.677 |
| | CA_AVR < 1 | | | |
| 42 | 0.1 < CA_Max/ | 0.808 | 0.816 | 0.801 |
| | (2*ImgH) < 1 | | | |

Table 3 shows the result values for Equations 43 to 76 described above in the optical system 1000 of FIG. 1. Referring to Table 3, the optical system 1000 may satisfy at least one or two of Equations 1 to 42 and at least one, two or more, or three or more of Equations 43 to 76. In detail, it may be seen that the optical system 1000 according to the embodiment satisfies all of the above equations 1 to 76. Accordingly, the optical system 1000 may improve optical performance and optical characteristics in the center and periphery portions of the FOV.

TABLE 3

| | | Embodi- | Embodi- | Embodi- |
|---|---|---|---|---|
| Equations | | ment1 | ment2 | ment3 |
| 43 | 0 < F/ | 0.775 | 0.778 | 0.809 |
| | L8R2 < 5 | | | |
| 44 | 0 < F/ | 1.916 | 1.923 | 1.916 |
| | L1R1< 10 | | | |
| 45 | 0 < EPD/ | 1.387 | 1.387 | 1.398 |
| | L9R2 < 10 | | | |
| 46 | 0 < EPD/ | 0.872 | 0.873 | 0.878 |
| | L1R1 < 10 | | | |
| 47 | 0 < F1/ | 7.426 | 156.634 | 45.122 |
| | F2 < 50 | | | |
| 48 | 0 < F13/ | 1.186 | 1.181 | 1.167 |
| | F < 5 | | | |
| 49 | 0 < IF49/ | 4.369 | 4.265 | 3.716 |
| | F131 < 10 | | | |
| 50 | 0 < F1/ | 14.540 | 123.560 | 37.000 |
| | F < 40 | | | |
| 51 | 5 < F1/ | 12.257 | 104.619 | 31.459 |
| | F13 < 40 | | | |
| 52 | 0 < 1F1/ | 2.806 | 24.532 | 8.465 |
| | F491 < 2 | | | |
| 53 | 0 < 1F1/ | 0.224 | 0.082 | 0.296 |
| | F41 < 1 | | | |
| 54 | 2 < | 6.160 | 6.160 | 6.170 |
| | TTL < 20 | | | |
| 55 | 2 < ImgH | 4.100 | 4.100 | 4.100 |
| 56 | BFL < 2.5 | 1.090 | 4.566 | 4.550 |
| 57 | 2 < F < 20 | 5.000 | 5.020 | 5.040 |
| 58 | FOV < 120 | 75.800 | 75.800 | 75.800 |
| 59 | 0.1 < TTL | 0.929 | 0.921 | 0.939 |
| | /CA_ | | | |
| | Max < 2 | | | |
| 60 | 0.5 < TTL/ | 1.502 | 1.502 | 1.505 |
| | ImgH < 3 | | | |
| 61 | 0.01 < BFL/ | 0.266 | 1.114 | 1.110 |
| | ImgH < 0.5 | | | |
| 62 | 4 < TTL/ | 5.653 | 1.349 | 1.356 |
| | BFL< 10 | | | |
| 63 | 0.5 < F/ | 0.812 | 0.815 | 0.817 |
| | TTL< 1.5 | | | |
| 64 | 3 < F/ | 4.588 | 1.099 | 1.108 |
| | BFL< 10 | | | |
| 65 | 0 < F/ | 1.220 | 1.224 | 1.229 |
| | ImgH < 3 | | | |
| 66 | 1 < F/ | 2.198 | 2.202 | 2.198 |
| | EPD < 5 | | | |
| 67 | 0 < BFL/ | 0.214 | 0.895 | 0.901 |
| | TD < 0.5 | | | |
| 68 | 0 < EPD/ | 0.007 | 0.007 | 0.007 |
| | ImgH/ | | | |
| | FOV < 0.2 | | | |
| 69 | 10 < FOV/ | 34.455 | 34.455 | 34.455 |
| | F# < 55 | | | |
| 70 | 15 < (TD_ | 24.786 | 24.767 | 24.750 |
| | LG2/TD_ | | | |
| | LG1)*n < 30 | | | |
| 71 | 5 < (CT_ | 10.882 | 10.890 | 10.980 |
| | Max + CG_ | | | |
| | Max)*n < 20 | | | |
| 72 | 40 < | 51.881 | 51.881 | 51.965 |
| | (FOV*TTL)/ | | | |
| | n < 100 | | | |
| 73 | (TTL*n) < | Satis- | Satis- | Satis- |
| | FOV | faction | faction | faction |
| 74 | 200 < CA_ | 303.518 | 307.100 | 298.688 |
| | Max*TD*n < | | | |
| | 400 | | | |
| 75 | 5 < (TD/CA_ | 9.106 | 9.028 | 8.935 |
| | Max) *n < 15 | | | |
| 76 | 15 < ((CA92/ | 19.658 | 19.762 | 19.356 |
| | CA41)/ | | | |
| | (CA11/ | | | |
| | CA32))*n < | | | |
| | 25 | | | |

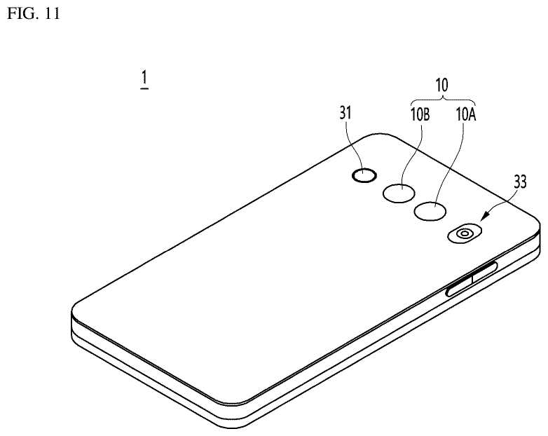

FIG. 11 is a diagram illustrating that a camera module according to an embodiment is applied to a mobile terminal.

Referring to FIG. 11, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy.

In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention.

Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to ninth lenses disposed along an optical axis toward a sensor side from an object side,
wherein the first lens has positive refractive power on the optical axis and has a meniscus shape convex toward the object side,
wherein the second lens has positive refractive power on the optical axis and has a shape in which both sides are convex,
wherein the ninth lens has negative refractive power on the optical axis and has a meniscus shape convex toward the object side,
wherein a lens with a maximum absolute value of focal lengths among the first to ninth lenses is the fourth lens,
wherein a lens surface with a maximum absolute value of curvature radii in the first to ninth lenses is an object-side surface of the sixth lens,
wherein a focal length of the first lens is F1,
wherein a focal length of the ninth lens is F9, and
wherein the following Equation satisfies: −0.5<F9/F1<0.

2. The optical system of claim 1,
wherein an optical axis distance from a center of an object-side surface of the first lens to an upper surface of the image sensor is TTL,
wherein ½ of a diagonal length of an image sensor is ImgH,
wherein the following Equation satisfies: 0.5<TTL/(2*ImgH)<0.9.

3. The optical system of claim 1,
wherein a refractive index of the first lens is n1 and an Abbe number of the first lens is v1,
wherein a refractive index of the third lens is n3 and an Abbe number of the third lens is v3,
wherein the following Equation satisfies: (v3*n3)<(v1*n1).

4. The optical system of claim 3,
wherein the following Equation satisfies: n1<1.6, where n1<n3 and v1>v3.

5. The optical system of claim 3,
wherein a refractive index of the second lens is n2 and an Abbe number of the second lens is v2,
wherein the following Equation satisfies: v3*n3<v2*n2.

6. The optical system of claim 3,
wherein a total focal length of the optical system is F,
wherein a brightness of the optical system is F #,
wherein the following Equation satisfies: 2<F/F #<4, where F #<2.3.

7. The optical system of claim 1,
wherein the sixth lens has positive refractive power.

8. The optical system of claim 1,
wherein a lens having a minimum effective diameter among the first to ninth lenses is the second lens, and a lens having a maximum effective diameter among the first to ninth lenses is the ninth lens.

9. The optical system of claim 1,
wherein a sensor-side surface of the third lens has a concave shape,
wherein a center distance between the third lens and the fourth lens is greater than a center distance between the second lens and the third lens, and is greater than a center distance between the fourth lens and the fifth lens.

10. The optical system of claim 1,
wherein an object-side surface of the fourth lens has a curvature radius of 500 mm or more on the optical axis.

11. An optical system comprising:
a first lens having a meniscus shape convex toward an object side;
a second lens disposed on a sensor side of the first lens;
a third lens disposed on a sensor side of the second lens;
a fourth lens disposed on a sensor side of the third lens;
an n-th lens closest to an image sensor;
an n-1th lens disposed on an object side of the n-th lens; and
two or more lenses disposed between the fourth lens and the n-1th lens,
wherein the second lens has a minimum effective diameter among the lenses,
wherein the n-th lens has a maximum effective diameter among the lenses of the optical system,
wherein the first lens to the n-th lens are aligned along an optical axis,
wherein a center distance between the third and fourth lenses is a maximum among center distances between the first to fourth lenses,
wherein a curvature radius of an object-side surface of the fourth lens is L4R1,
wherein a curvature radius of a sensor-side surface of the fourth lens is L4R2, and
wherein the following Equation satisfies: 100<|L4R2|<|L4R1|.

12. The optical system of claim 11,
wherein a sum of center thicknesses of the first to n-th lenses is ΣCT,
wherein a sum of center distances between the first to n-th lenses is ΣCG, and
wherein the following Equation satisfies: ΣCG<ΣCT.

13. The optical system of claim 12,
wherein a total number of lenses is n,
wherein the following Equation satisfies: 5<(CT_Max+CG_Max)*n<20.

14. The optical system of claim 11,
wherein a number of lenses with a refractive index of less than 1.6 at a d-line among the lenses is 5 or more, and
wherein a number of lenses with an Abbe number of more than 45 among the lenses is 5 or more.

15. The optical system of claim 11,
wherein a sum of refractive indices at the d-line of the lenses is ΣIndex,
wherein a sum of Abbe numbers of the lenses is ΣAbbe,
wherein the following Equation satisfies: 10<ΣAbbe/ΣIndex<50.

16. The optical system of claim 15,
wherein an optical axis distance from a center of the object-side surface of the first lens to an upper surface of an image sensor is TTL,
wherein ½ of a diagonal length of the image sensor is ImgH,
wherein the following Equation satisfies: 1<TTL/ImgH<2.

17. The optical system of claim 11,
wherein an object-side surface and a sensor-side surface of the n-th lens have a critical point,
wherein an object-side surface and a sensor-side surface of the n-1th lens have a critical point,
wherein the critical point of the sensor-side surface of the n-th lens is disposed closer to an edge than the critical points of the object-side and sensor-side surfaces of the n-1th lens.

18. An optical system comprising:
a first lens group having first to third lenses on an object side;
a second lens group disposed on a sensor side of the first lens group and having five or more lenses and seven or less lenses; and
an aperture stop disposed around an object-side surface or sensor-side surface of the second lens,
wherein the first lens group has positive refractive power,
wherein the second lens group has negative refractive power,
wherein the second lens has a convex object-side surface and a convex sensor-side surface on the optical axis,
wherein an optical axis distance from an object side center of the first lens group to an image sensor is TTL,
wherein a field of view of the optical system is FOV,
wherein ½ of a diagonal length of the image sensor is ImgH,
wherein n is a total number of lenses,
wherein the following Equation satisfies: (TTL*n)<FOV wherein the following Equation satisfies: 0.5<TTL/(2*ImgH)<0.9.

19. A camara module comprising:
an image sensor disposed on a sensor side of the plurality of lenses; and
an optical filter disposed between an image sensor and a last lens of the optical system,
wherein the optical system includes an optical system according to claim 1,
wherein F is a total focal length,
wherein TTL is a distance in an optical axis from a center of an object-side surface of a lens closest to an object side to an upper surface of the image sensor,
wherein ImgH is ½ of a maximum diagonal length of the image sensor,
wherein the following Equations satisfy: 0.5<F/TTL<1.5, and 1<TTL/ImgH<2.

20. The optical system of claim 18,
wherein the second lens group includes fourth to ninth lenses aligned with an optical axis toward the sensor side from the object side,
wherein the first lens has positive (+) refractive power on the optical axis and has a meniscus shape convex toward the object side,
wherein the second lens has positive refractive power on the optical axis,
wherein the ninth lens has negative (−) refractive power on the optical axis and has a meniscus shape convex toward the object side.
